(19) United States
(12) Patent Application Publication
(10) Pub. No.: US 2013/0165598 A1
(43) Pub. Date: Jun. 27, 2013

(54) Liquid Crystal Photoalignment Agent, Liquid Crystal Photoalignment Film Using the Same, and Liquid Crystal Display Device Including the Liquid Crystal Photoalignment Film

(71) Applicants: Yong-Sik YOO, Uiwang-si (KR); Jae-Deuk YANG, Uiwang-si (KR); Guk-Pyo JO, Uiwang-si (KR)

(72) Inventors: Yong-Sik YOO, Uiwang-si (KR); Jae-Deuk YANG, Uiwang-si (KR); Guk-Pyo JO, Uiwang-si (KR)

(73) Assignee: CHEIL INDUSTRIES INC., Gumi-si (KR)

(21) Appl. No.: 13/591,517

(22) Filed: Aug. 22, 2012

(30) Foreign Application Priority Data
Dec. 22, 2011 (KR) 10-2011-0140555

(51) Int. Cl. C08G 12/00; C08L 67/00; C08L 79/08; C08G 73/10

(52) U.S. Cl. 525/421; 528/229

(57) ABSTRACT

Disclosed are a liquid crystal photoalignment agent, a liquid crystal photoalignment film using the same, and a liquid crystal display including the liquid crystal photoalignment film. The liquid crystal photoalignment agent includes a polymer including polyamic acid including a repeating unit represented by Chemical Formula 1, polyimide including a repeating unit represented by Chemical Formula 2, or a combination thereof, or includes a first polymer including polyamic acid including a repeating unit represented by Chemical Formula 5, polyimide including a repeating unit represented by Chemical Formula 6, or a combination thereof; and a second polymer including polyamic acid including a repeating unit represented by Chemical Formula 7, polyimide including a repeating unit represented by Chemical Formula 8, or a combination thereof, wherein Chemical Formulae 1, 2 and 5 to 8 are the same as defined in the detailed description.

### CROSS-REFERENCE TO RELATED APPLICATIONS

This application claims priority to and the benefit of Korean Patent Application No. 10-2011-0140555 filed in the Korean Intellectual Property Office on Dec. 22, 2011, the entire disclosure of which is incorporated herein by reference.

### FIELD

This disclosure relates to a liquid crystal photoalignment agent, a liquid crystal photoalignment film using the same, and a liquid crystal display including the liquid crystal photoalignment film.

### BACKGROUND

A liquid crystal display device (LCD) includes liquid crystal twisted 90° between a polarizer and an analyzer which have polarization directions vertical to each other. When applying no voltage, linearly-polarized light passing the polarizer is locally rotated along with the direction of other liquid crystal alignment body and deflected 90°. As a result, the light is rotated and passed through an analyzer when passing a liquid crystal layer. When applying voltage, since the liquid crystal is aligned in a direction parallel to the electric field direction, the linearly-polarized light is passed through the liquid crystal layer without rotation, so it is blocked by the analyzer due to the vertically-polarized direction of analyzer, so not to be passed. In this manner, light may be selectively transmitted by controlling the liquid crystal, so it is very important to uniformly align the liquid crystal through the whole LCD panel in order to provide uniform brightness and high contrast ratio.

The conventional method of aligning the liquid crystal includes coating a polymer membrane such as a polyimide on a substrate made of a material such as glass, and rubbing the surface of the substrate with a fiber such as nylon or polyester in a predetermined direction. Recently, there has been research on a photo-alignment method causing a photo-crosslinking reaction and the like anisotropically by a polarized photo-radiation rather than friction and thus, bringing about anisotropy on the surface of a polymer, which results in liquid crystal molecules being aligned in one direction.

A liquid crystal display may be fabricated by coating a liquid crystal photo-alignment agent on a glass substrate deposited with a transparent indium tin oxide (ITO) conductive layer and heating it to form an alignment film, and then combining two substrates oppositely facing each other and implanting the liquid crystals therebetween. Alternatively, a liquid crystal display may be fabricated by dripping liquid crystals on one substrate and combining it with another substrate oppositely facing the one substrate. In particular, a liquid crystal display of the 5^{th} generation or later in a medium- and large-sized product line tends to adopt the latter method.

These liquid crystal photoalignment film materials should have excellent chemical stability and thermal stability and should not result in an after-image on a liquid crystal display. In addition, these liquid crystal photoalignment film materials should have excellent printability. When a liquid crystal photoalignment agent has poor printability, a liquid crystal photoalignment film may not have uniform thickness, which may negatively influence characteristics of a liquid crystal display. In addition, the liquid crystal photoalignment film should be cured at a temperature of less than or equal to about 200° C. in order to minimize harm to contrast ratio and luminance of a color filter composition.

A curing reaction has been promoted by adding a catalyst thereto. However, while the additive may lower the temperature of the curing reaction, it can remain as an ionic material after the curing and deteriorate electrical properties and the like.

### SUMMARY

One embodiment provides a liquid crystal photoalignment agent that can be stable when subject to changes in process conditions, can have excellent printability and chemical resistance, and can be cured at a low temperature.

Another embodiment provides a liquid crystal photoalignment film manufactured using the liquid crystal photoalignment agent.

Yet another embodiment provides a liquid crystal display including the liquid crystal photoalignment film.

According to one embodiment, provided is a liquid crystal photoalignment agent that includes a polymer including polyamic acid including a repeating unit represented by the following Chemical Formula 1, polyimide including a repeating unit represented by the following Chemical Formula 2, or a combination thereof.

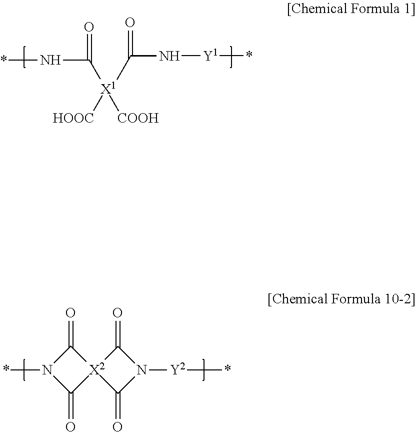

In Chemical Formulae 1 and 2,

X¹ and X² are the same or different and are each independently a tetravalent organic group derived from alicyclic acid dianhydride or aromatic acid dianhydride, and

Y¹ and Y² are the same or different and are each independently a divalent organic group derived from diamine, wherein the diamine includes a photodiamine and at least one diamine represented by the following Chemical Formulae 3 and 4 or a combination thereof.

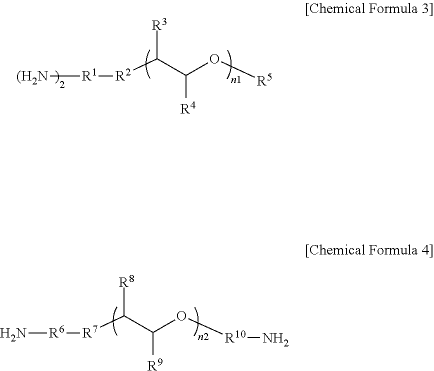

In Chemical Formulae 3 and 4,

R¹ and R⁶ are the same or different and are each independently a substituted or unsubstituted aliphatic organic group, a substituted or unsubstituted alicyclic organic group, or a substituted or unsubstituted aromatic organic group,

R² and R⁷ are the same or different and are each independently a single bond, —O—, —CO—O—, —CO—NH—, —NH—CO—, or —O—CO—,

R³, R⁴, R⁵, R⁸ and R⁹ are the same or different and are each independently hydrogen, substituted or unsubstituted C1 to C20 alkyl, or substituted or unsubstituted C6 to C30 aryl,

R¹⁰ is a single bond, substituted or unsubstituted C1 to C20 alkylene, or substituted or unsubstituted C6 to C30 arylene, and

n¹ and n² are the same or different and are independently integers ranging from 1 to 100.

The photodiamine may include without limitation at least one compound represented by the following Chemical Formula 9-1 to 9-9, or a combination thereof.

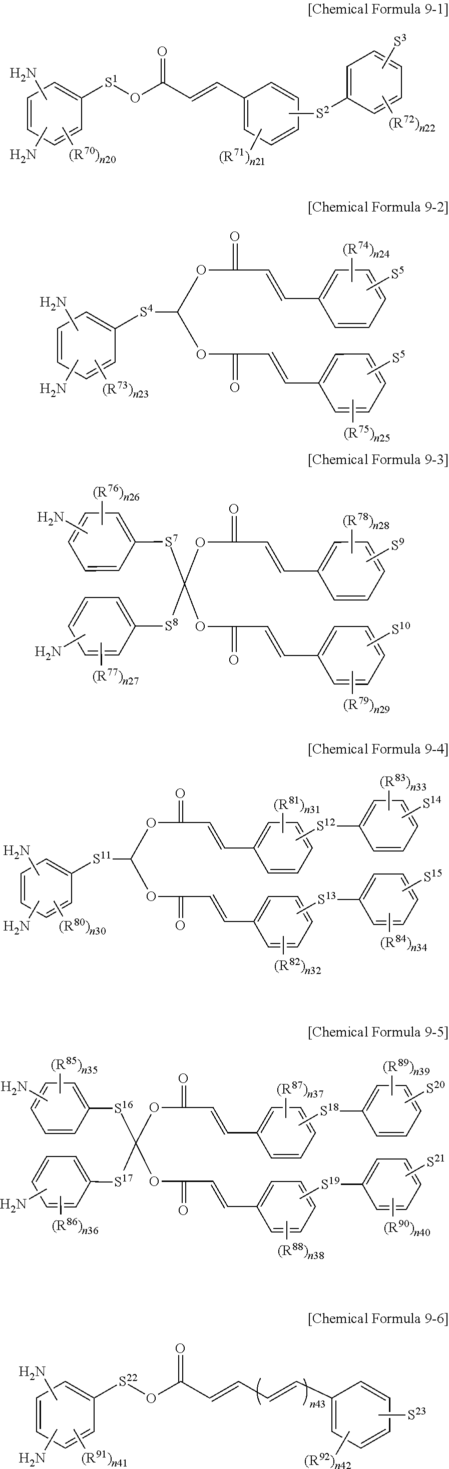

In Chemical Formulae 9-1 to 9-6,

S¹, S², S⁴, S⁷, S⁸, S¹¹, S¹², S¹³, S¹⁶, S¹⁷, S¹⁸, S¹⁹, and S²² are the same or different and are each independently a single bond, substituted or unsubstituted C1 to C10 alkylene, —O—, —CO—O—, —CO—NH—, —NH—CO—, or —O—CO—,

S³, S⁵, S⁶, S⁹, S¹⁰, S¹⁴, S¹⁵, S²⁰, S²¹, and S²³ are the same or different and are each independently substituted or unsubstituted C1 to C30 alkyl, substituted or unsubstituted C1 to C30 alkoxy, or substituted or unsubstituted C2 to C30 ether,

R⁷⁰ to R⁹² are the same or different and are each independently hydrogen or substituted or unsubstituted C1 to C10 alkyl,

n²⁰, n²³, n³⁰ and n⁴¹ are the same or different and are each independently integers ranging from 0 to 3,

n²¹, n²², n²⁴ to n²⁹, n³¹ to n⁴⁰, and n⁴² are the same or different and are each independently integers ranging from 0 to 4, and

n⁴³ is an integer ranging from 0 to 5.

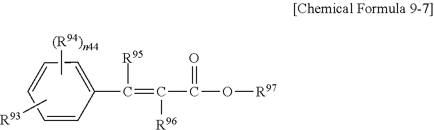

In Chemical Formula 9-7,

R⁹³ is a diamine group including a substituted or unsubstituted C6 to C30 aromatic diamine group or substituted or unsubstituted linear or branched C1 to C24 alkylene diamine group,

each R⁹⁴ is independently hydrogen, substituted or unsubstituted C1 to C20 alkyl, substituted or unsubstituted C6 to C30 aryl, or substituted or unsubstituted C2 to C30 heteroaryl,

n⁴⁴ is an integer ranging from 0 to 4,

R⁹⁵ and R⁹⁶ are the same or different and are each independently hydrogen, halogen, a cyano group, or substituted or unsubstituted C1 to C12 alkyl, and

R⁹⁷ is hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group.

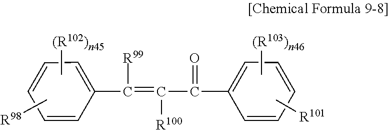

In Chemical Formula 9-8,

R⁹⁸ is a diamine group including a substituted or unsubstituted C6 to C30 aromatic diamine group or substituted or unsubstituted linear or branched C1 to C24 alkylene diamine group,

R¹⁰² and R¹⁰³ are the same or different and are each independently hydrogen, substituted or unsubstituted C1 to C20 alkyl, substituted or unsubstituted C6 to C30 aryl, or substituted or unsubstituted C2 to C30 heteroaryl,

n⁴⁵ and n⁴⁶ are the same or different and are each independently integers ranging from 0 to 4,

R⁹⁹ and R¹⁰⁰ are the same or different and are each independently hydrogen, halogen, a cyano group, or substituted or unsubstituted C1 to C12 alkyl, and

R¹⁰¹ is hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group.

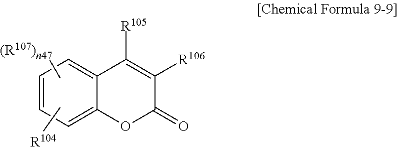

In Chemical Formula 9-9,

R¹⁰⁴ is a diamine group including a substituted or unsubstituted C6 to C30 aromatic diamine group or substituted or unsubstituted linear or branched C1 to C24 alkylene diamine group,

each R¹⁰⁷ is independently hydrogen, substituted or unsubstituted C1 to C20 alkyl, substituted or unsubstituted C6 to C30 aryl, or substituted or unsubstituted C2 to C30 heteroaryl,

n⁴⁷ is an integer ranging from 0 to 3, and

R¹⁰⁵ and R¹⁰⁶ are the same or different and are each independently hydrogen, halogen, a cyano group, or substituted or unsubstituted C1 to C12 alkyl.

The photodiamine may include without limitation at least one compound represented by the following Chemical Formulae 10-1 and 10-2 or a combination thereof.

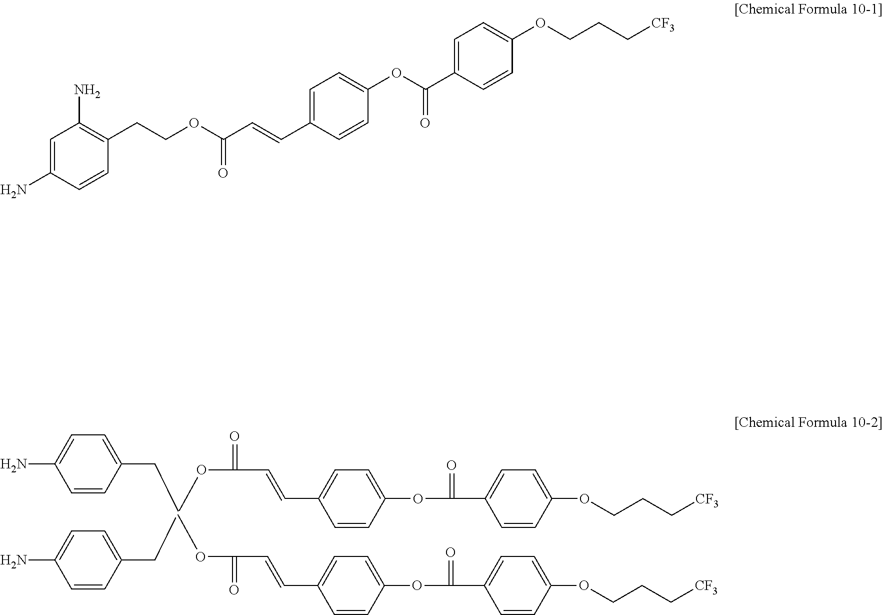

The at least one diamine of Chemical Formulae 3 and/or 4 may include without limitation at least one compound represented by the following Chemical Formulae 11 and 12 or a combination thereof.

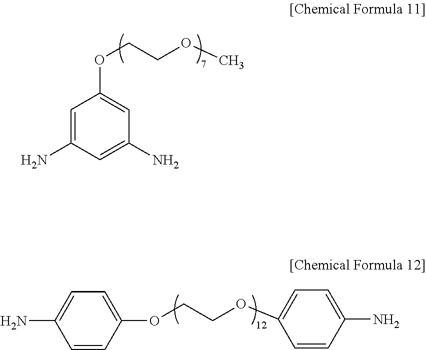

The diamine may include about 85 to about 99 mol % of the photodiamine and about 1 to about 15 mol % of at least one diamine selected from the above Chemical Formulae 3 and 4.

The polymer may have a weight average molecular weight of about 100,000 to about 500,000 g/mol.

The liquid crystal photoalignment agent may have a solid content of about 0.1 to about 30 wt %.

According to another embodiment, provided is liquid crystal photoalignment agent that includes a first polymer including polyamic acid including a repeating unit represented by the following Chemical Formula 5, polyimide including a repeating unit represented by the following Chemical Formula 6, or a combination thereof; and a second polymer including polyamic acid including a repeating unit represented by the following Chemical Formula 7, polyimide including a repeating unit represented by the following Chemical Formula 8, or a combination thereof.

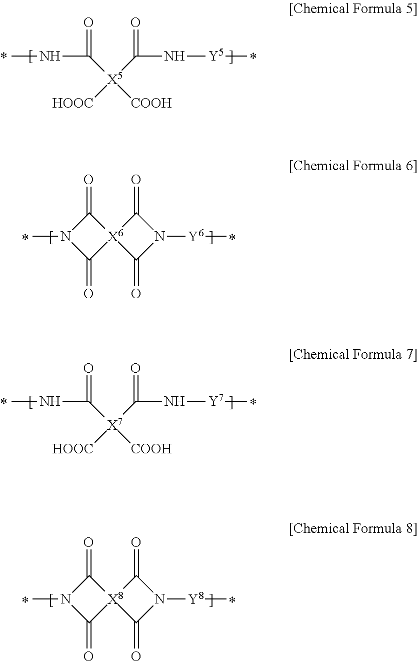

In Chemical Formulae 5 to 8,

X⁵ to X⁸ are the same or different and are each independently a tetravalent organic group derived from alicyclic acid dianhydride or aromatic acid dianhydride,

Y⁵ and Y⁶ are the same or different and are each independently a divalent organic group derived from photodiamine, and

Y⁷ and Y⁸ the same or different and are each independently a divalent organic group derived from at least one diamine selected from the following Chemical Formulae 3 and 4.

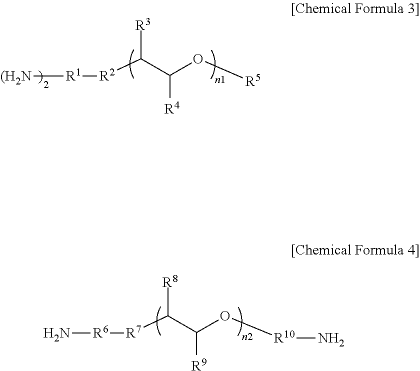

In Chemical Formulae 3 and 4,

R¹ and R⁶ are the same or different and are each independently a substituted or unsubstituted aliphatic organic group, a substituted or unsubstituted alicyclic organic group, or a substituted or unsubstituted aromatic organic group,

R² and R⁷ are the same or different and are each independently a single bond, —O—, —CO—O—, —CO—NH—, —NH—CO—, or —O—CO—,

R³, R⁴, R⁵, R⁸ and R⁹ are the same or different and are each independently hydrogen, substituted or unsubstituted C1 to C20 alkyl, or substituted or unsubstituted C6 to C30 aryl,

R¹⁰ is a single bond, substituted or unsubstituted C1 to C20 alkylene, or substituted or unsubstituted C6 to C30 arylene, and

n¹ and n² are the same or different and are each independently integers ranging from 1 to 100.

The liquid crystal photoalignment agent may include about 85 to about 99 mol % of the first polymer and about 1 to about 15 mol % of the second polymer.

The first polymer and the second polymer may have a weight average molecular weight of about 100,000 to about 500,000 g/mol, respectively.

According to another embodiment, a liquid crystal photoalignment film that is manufactured by applying the liquid crystal photoalignment agent on a substrate is provided.

According to yet another embodiment, a liquid crystal display including the liquid crystal photoalignment film is provided.

Hereinafter, further embodiments will be described in detail.

The liquid crystal photoalignment agent can be stable when subject to changes in process conditions, can have excellent printability and chemical resistance, and can be curable at a low temperature. Further, the liquid crystal photoalignment film can have excellent alignment properties and electrical properties.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” may refer to one substituted with halogen (F, Cl, Br, or I), a hydroxyl group, a C1 to C20 alkoxy group, a nitro group, a cyano group, an amino group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, C1 to C20 alkyl, C₂ to C₂₀ alkenyl, C2 to C20 alkynyl, C6 to C30 aryl, C3 to C20 cycloalkyl, C3 to C20 cycloalkenyl, C3 to C20 cycloalkynyl, C2 to C20 heterocycloalkyl, C2 to C20 heterocycloalkenyl, C2 to C20 heterocycloalkynyl, C3 to C30 heteroaryl, or a combination thereof, instead of at least one hydrogen.

As used herein, when a specific definition is not otherwise provided, the term “alkylenearyl” may refer to a substituent including C1 to C20 alkylene linked to C6 to C30 aryl, the term “arylenealkyl” may refer to a substituent including C₆ to C₃₀ arylene linked to C1 to C20 alkyl, the term “alkylenearylene” may refer to a substituent including C1 to C20 alkylene linked to C6 to C30 arylene, and the term “arylenealkylene” may refer to a substituent including C6 to C30 arylene linked to C1 to C20 alkylene.

As used herein, when a specific definition is not otherwise provided, the term “hetero” may refer to one including at least one hetero atom N, O, S, P or a combination thereof in place or one or more carbon atoms in a ring.

As used herein, when a specific definition is not otherwise provided, the term “aliphatic” may refer to C1 to C40 alkyl, C2 to C40 alkenyl, C2 to C40 alkynyl, C1 to C40 alkylene, C2 to C40 alkenylene, or C2 to C40 alkynylene, for example C1 to C20 alkyl, C2 to C20 alkenyl, C2 to C20 alkynyl, C1 to C20 alkylene, C2 to C20 alkenylene, or C2 to C20 alkynylene, the term “alicyclic” may refer to C3 to C40 cycloalkyl, C3 to C40 cycloalkenyl, C3 to C40 cycloalkynyl, C3 to C40 cycloalkylene, C3 to C40 cycloalkenylene, or C3 to C40 cycloalkynylene, for example C3 to C20 cycloalkyl, C3 to C20 cycloalkenyl, C3 to C20 cycloalkynyl, C3 to C20 cycloalkylene, C3 to C20 cycloalkenylene, or C3 to C20 cycloalkynylene, and the term “aromatic” may refer to C6 to C40 aryl, C2 to C40 heteroaryl, C6 to C40 arylene, or C2 to C40 heteroarylene, for example C6 to C16 aryl, C2 to C16 heteroaryl, C6 to C16 arylene, or C2 to C16 heteroarylene.

As used herein, when a specific definition is not otherwise provided, the term “(meth)acrylate” may refer to “acrylate” and “methacrylate”, and the term “(meth)acrylic acid” may refer to “acrylic acid” and “methacrylic acid.”

As used herein, when a specific definition is not otherwise provided, the term “combination” may refer to a mixture or copolymerization, and in an alicyclic organic group and an aromatic organic group, at least two rings forming a fused ring, or at least two rings linked through a functional group such as a single bond, O, S, C(═O), CH(OH), S(═O), S(═O)₂, Si(CH₃)₂, (CH₂)ₚ (wherein, 1≦p≦2), (CF₂)_{q} (wherein, 1≦q≦2), C(CH₃)₂, C(CF₃)₂, C(CH₃)(CF₃), or C(═O)NH. Herein, the term “copolymerization” may refer to block copolymerization, random copolymerization, or graft copolymerization, and the term “copolymer” may refer to a block copolymer, a random copolymer, or a graft copolymer.

The liquid crystal photoalignment agent according to one embodiment includes a polymer, which will be described hereinafter.

(A) Polymer

The polymer may include polyamic acid including a repeating unit represented by the following Chemical Formula 1, polyimide including a repeating unit represented by the following Chemical Formula 2, or a combination thereof.

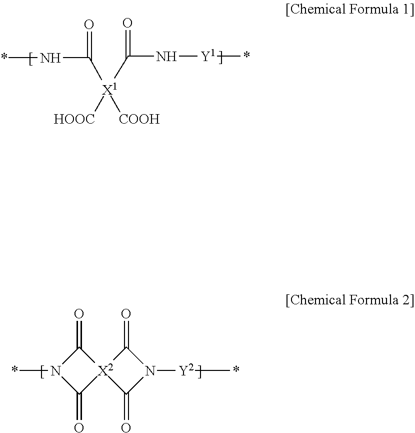

In Chemical Formulae 1 and 2, X¹ and X² are the same or different and are each independently a tetravalent organic group derived from alicyclic acid dianhydride or aromatic acid dianhydride.

In Chemical Formulae 1 and 2, Y¹ and Y² are the same or different and are each independently a divalent organic group derived from diamine. The diamine may include a photodiamine and at least one diamine represented by the following Chemical Formulae 3 and 4 or a combination thereof.

Thus, a repeating unit including an organic group derived from the photodiamine and a repeating unit including an organic group derived from at least one diamine selected from the above Chemical Formulae 3 and 4 and combinations thereof are present in one polymer. That is, the photodiamine and at least one diamine selected from the above Chemical Formulae 3 and 4 and combinations may be copolymerized with each other to provide one polymer. As described above, when the photodiamine and at least one diamine selected from the above Chemical Formulae 3 and 4 and combinations thereof are copolymerized with each other to provide one polymer in a liquid crystal photoalignment agent, the liquid crystal photoalignment agent may be stable when subject to changes in process conditions, can have improved printability and chemical resistance, and may be curable at a low temperature.

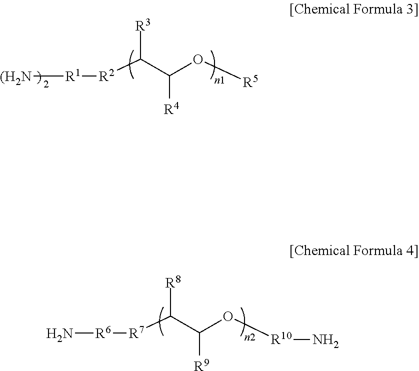

In Chemical Formulae 3 and 4, R¹ and R⁶ are the same or different and are each independently a substituted or unsubstituted aliphatic organic group, a substituted or unsubstituted alicyclic organic group, or a substituted or unsubstituted aromatic organic group. In one embodiment, R¹ and R⁶ may be a substituted or unsubstituted aromatic organic group.

In Chemical Formulae 3 and 4, R² and R⁷ are the same or different and are each independently a single bond, —O—, —CO—O—, —CO—NH—, —NH—CO—, or —O—CO—, and in one embodiment, R² and R⁷ may be —O—.

In Chemical Formulae 3 and 4, R³, R⁴, R⁵, R⁸ and R⁹ are the same or different and are each independently hydrogen, substituted or unsubstituted C1 to C20 alkyl, or substituted or unsubstituted C6 to C30 aryl.

In Chemical Formulae 3 and 4, R¹⁰ is a single bond, substituted or unsubstituted C1 to C20 alkylene, or substituted or unsubstituted C6 to C30 arylene. In one embodiment, R¹⁰ may be substituted or unsubstituted C6 to C30 arylene.

In Chemical Formulae 3 and 4, n¹ and n² are the same or different and are each independently an integer of 1 to 100.

When at least one diamine of Chemical Formulae 3 and/or 4 forms one polymer with the photodiamine, a flexible part may be provided in a polymer and thus polymer mobility can increase, which can improve the degree of curing during curing at a low temperature.

The diamine may include about 85 to about 99 mol % of the photodiamine and about 1 to about 15 mol % of at least one diamine of Chemical Formula 3, Chemical Formula 4, or a combination thereof, for example about 90 to about 95 mol % of the photodiamine and about 5 to about 10 mol % of at least one diamine of Chemical Formula 3, Chemical Formula 4, or a combination thereof.

In some embodiments, the diamine may include the photodiamine in an amount of about 85, 86, 87, 88, 89, 90, 91, 92, 93, 94, 95, 96, 97, 98, or 99 mol %. Further, according to some embodiments of the present invention, the amount of the photodiamine can be in a range from about any of the foregoing amounts to about any other of the foregoing amounts.

In some embodiments, the diamine may include the at least one diamine of Chemical Formula 3, Chemical Formula 4, or a combination thereof in an amount of about 1, 2, 3, 4, 5, 6, 7, 8, 9, 10, 11, 12, 13, 14, or 15 mol %. Further, according to some embodiments of the present invention, the amount of the at least one diamine of Chemical Formula 3, Chemical Formula 4, or a combination thereof can be in a range from about any of the foregoing amounts to about any other of the foregoing amounts.

When the diamine includes the photodiamine and at least one diamine of Chemical Formula 3, Chemical Formula 4, or a combination thereof in an amount within the above ratio ranges, the liquid crystal photoalignment agent may be stable when subject to changes in process conditions, can have improved printability and chemical resistance, and may be curable at a low temperature.

The polymer may have a weight average molecular weight of about 100,000 to about 500,000 g/mol, for example about 100,000 to about 300,000 g/mol. When the polymer has a weight average molecular weight within the above range, fluidity can be excellent, and thermal stability and chemical resistance may be improved because it is curable at a low temperature.

The polymer may include a first polymer including polyamic acid including a repeating unit represented by the following Chemical Formula 5, polyimide including a repeating unit represented by the following Chemical Formula 6, or a combination thereof; and a second polymer including polyamic acid including a repeating unit represented by the following Chemical Formula 7, polyimide including a repeating unit represented by the following Chemical Formula 8, or a combination thereof. That is, at least two kinds of the first polymer and the second polymer may be mixed with each other.

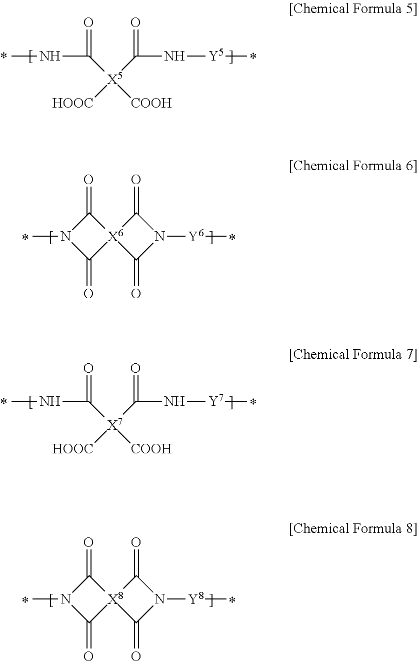

In Chemical Formulae 5 and 8, X⁵ to X⁸ are the same or different and are each independently a tetravalent organic group derived from alicyclic acid dianhydride or aromatic acid dianhydride.

In Chemical Formulae 5 and 8, Y⁵ and Y⁶ are the same or different and are each independently a divalent organic group derived from photodiamine, and Y⁷ and Y⁸ are the same or different and are each independently a divalent organic group derived from at least one diamine selected from the above Chemical Formulae 3 and 4, or a combination thereof. That is, a first polymer including an organic group derived from the photodiamine, and a second polymer including an organic group derived from at least one diamine selected from the above Chemical Formulae 3 and/or 4 may be mixed with each other. As described above, when the photodiamine and the at least one diamine selected from the above Chemical Formulae 3 and/or 4 is used as a mixture of polymers in a liquid crystal photoalignment agent, the liquid crystal photoalignment agent may be stable when subject to changes in process conditions, can have improved printability and chemical resistance, and may be curable at a low temperature.

The polymer may include about 85 to about 99 mol % of the first polymer and about 1 to about 15 mol % of the second polymer, for example about 90 to about 95 mol % of the first polymer and about 5 to about 10 mol % of the second polymer.

In some embodiments, the polymer may include the first polymer in an amount of about 85, 86, 87, 88, 89, 90, 91, 92, 93, 94, 95, 96, 97, 98, or 99 mol %. Further, according to some embodiments of the present invention, the amount of the first polymer can be in a range from about any of the foregoing amounts to about any other of the foregoing amounts.

In some embodiments, the polymer may include the second polymer in an amount of about 1, 2, 3, 4, 5, 6, 7, 8, 9, 10, 11, 12, 13, 14, or 15 mol %. Further, according to some embodiments of the present invention, the amount of the second polymer can be in a range from about any of the foregoing amounts to about any other of the foregoing amounts.

When the polymer includes the first polymer and the second polymer in an amount within the above ratio ranges, the liquid crystal photoalignment agent may be stable when subject to changes in process conditions, can have improved printability and chemical resistance, and may be curable at a low temperature.

The first polymer may have a weight average molecular weight of about 100,000 to about 500,000 g/mol, for example about 100,000 to about 300,000 g/mol. The second polymer may have a weight average molecular weight of about 100,000 to about 500,000 g/mol, for example about 100,000 to about 300,000 g/mol. When the first polymer and the second polymer have weight average molecular weights within the above ranges, fluidity can be excellent, and thermal stability and chemical resistance may be improved because it is curable at a low temperature.

Examples of the photodiamine used in copolymerization and in a mixture of the polymers may include without limitation azobenzene-based photodiamines, cinnamate-based photodiamines, chalcone-based photodiamines, cumarine-based photodiamines, and the like, and combinations thereof.

The photodiamine may include without limitation at least one compound represented by the following Chemical Formulae 9-1 to 9-9, or a combination thereof.

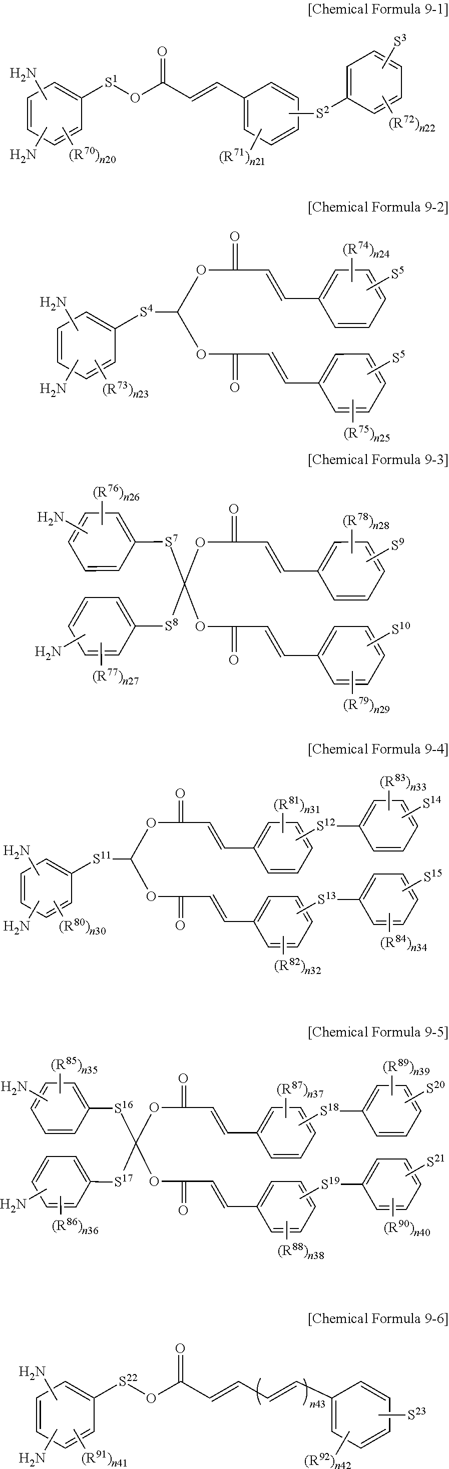

In Chemical Formulae 9-1 to 9-6, S¹, S², S³, S⁴, S⁷, S⁸, S¹¹, S¹², S¹³, S¹⁶, S¹⁷, S¹⁸, S¹⁹, and S²² are the same or different and are each independently a single bond, substituted or unsubstituted C1 to C10 alkylene, —O—, —CO—O—, —CO—NH—, —NH—CO—, or —O—CO—.

In Chemical Formulae 9-1 to 9-6, S³, S⁵, S⁶, S⁹, S¹⁰, S¹⁴, S¹⁵, S²⁰, S²¹, and S²³ are the same or different and are each independently substituted or unsubstituted C1 to C30 alkyl, substituted or unsubstituted C1 to C30 alkoxy, or substituted or unsubstituted C2 to C30 ether group.

In Chemical Formulae 9-1 to 9-6, R⁷⁰ to R⁹² are the same or different and are each independently hydrogen or substituted or unsubstituted C1 to C10 alkyl.

In Chemical Formulae 9-1 to 9-6, n²⁰, n²³, n³⁰, and n⁴¹ are the same or different and are each independently an integer of 0 to 3,

n²¹, n²², n²⁴ to n²⁹, n³¹ to n⁴⁰ and n⁴² are the same or different and are each independently an integer of 0 to 4, and

n⁴³ may be an integer of 0 to 5.

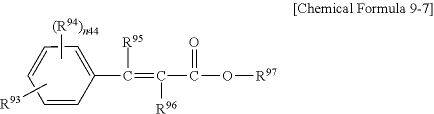

In Chemical Formula 9-7, R⁹³ may be a diamine group including a substituted or unsubstituted C6 to C30 aromatic diamine group or substituted or unsubstituted linear or branched C1 to C24 alkylene diamine group.

In Chemical Formula 9-7, each R⁹⁴ may independently be hydrogen, substituted or unsubstituted C1 to C20 alkyl, substituted or unsubstituted C6 to C30 aryl, or substituted or unsubstituted C2 to C30 heteroaryl.

In Chemical Formula 9-7, n⁴⁴ may be an integer of 0 to 4.

In Chemical Formula 9-7, R⁹⁵ and R⁹⁶ are the same or different and are each independently hydrogen, halogen, a cyano group, or substituted or unsubstituted C1 to C12 alkyl.

In Chemical Formula 9-7, R⁹⁷ may be hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group.

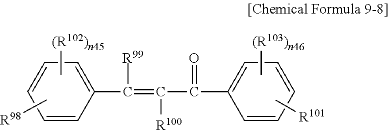

In Chemical Formula 9-8, R⁹⁸ is a diamine group including a substituted or unsubstituted C6 to C30 aromatic diamine group or a substituted or unsubstituted linear or branched C1 to C24 linear or branch alkylene diamine group.

In Chemical Formula 9-8, R¹⁰² and R¹⁰³ are the same or different and are each independently hydrogen, substituted or unsubstituted C1 to C20 alkyl, substituted or unsubstituted C6 to C30 aryl, or substituted or unsubstituted C2 to C30 heteroaryl.

In Chemical Formula 9-8, n⁴⁵ and n⁴⁶ are the same or different and are each independently integers of 0 to 4.

In Chemical Formula 9-8, R⁹⁹ and R¹⁰⁰ are the same or different and are each independently hydrogen, halogen, a cyano group, or substituted or unsubstituted C1 to C12 alkyl.

In Chemical Formula 9-8, R¹⁰¹ is hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group.

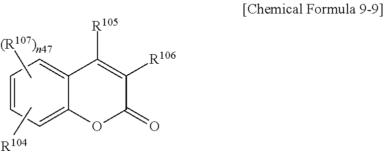

In Chemical Formula 9-9, R¹⁰⁴ is a diamine group including a substituted or unsubstituted C6 to C30 aromatic diamine group or substituted or unsubstituted linear or branched C1 to C24 alkylene diamine group.

In Chemical Formula 9-9, each R¹⁰⁷ is independently hydrogen, substituted or unsubstituted C1 to C20 alkyl, substituted or unsubstituted C6 to C30 aryl, or substituted or unsubstituted C2 to C30 heteroaryl.

In Chemical Formula 9-9, n⁴⁷ may be an integer of 0 to 3.

In Chemical Formula 9-9, R¹⁰⁵ and R¹⁰⁶ are the same or different and are each independently hydrogen, halogen, a cyano group, or substituted or unsubstituted C1 to C12 alkyl.

The photodiamine may include without limitation at least one compound represented by the following Chemical Formulae 10-1 and 10-2, or a combination thereof.

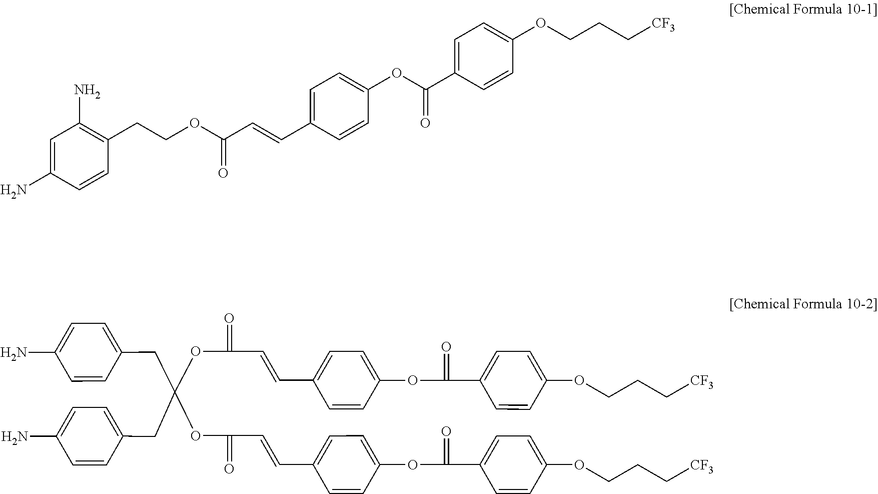 [SMILES: Nc1ccc(CCOC(=O)/C=C/c2ccc(OC(=O)c3ccc(OCCCC(F)(F)F)cc3)cc2)c(N)c1 ; Nc1ccc(CC(Cc2ccc(N)cc2)(OC(=O)/C=C/c2ccc(OC(=O)c3ccc(OCCCC(F)(F)F)cc3)cc2)OC(=O)/C=C/c2ccc(OC(=O)c3ccc(OCCCC(F)(F)F)cc3)cc2)cc1]

The at least one diamine selected from the above Chemical Formulae 3 and/or 4 that is used as a copolymerization or a mixture of polymers with the photodiamine may include without limitation at least one compound represented by the following Chemical Formulae 11 and 12, or a combination thereof.

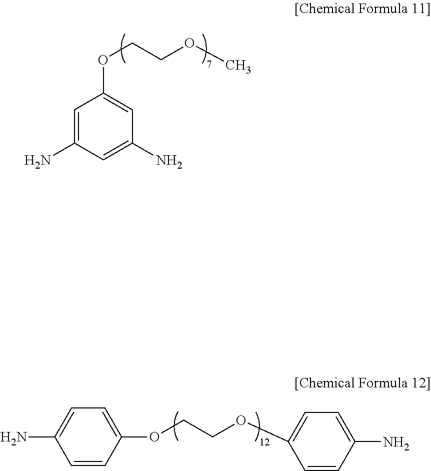

The diamine may further include at least one compound selected from aromatic diamines, functional diamines, and combinations thereof, in addition to the photodiamine and at least one diamine selected from the above Chemical Formulae 3 and/or 4. The photodiamine and at least one diamine selected from the above Chemical Formulae 3 and/or 4 may be used together as monomers in the formation of a copolymer or used together as monomers in the formation of a mixture of polymers.

The aromatic diamine may include without limitation at least one compound represented by the following Chemical Formulae 13-1 to 13-4, or a combination thereof.

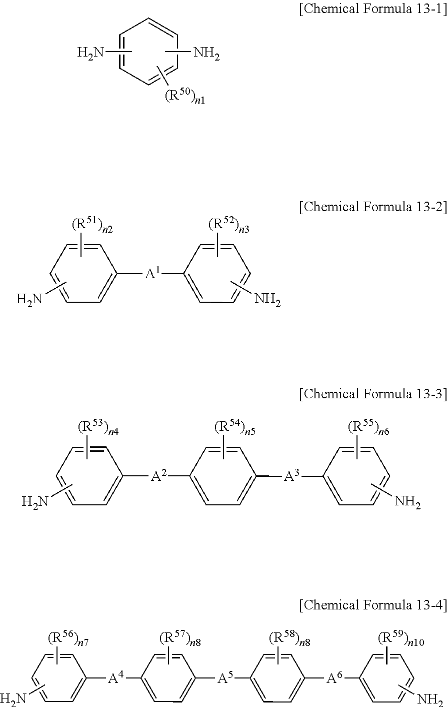

In Chemical Formulae 13-1 to 13-4, R⁵⁰ to R⁵⁹ are the same or different and are each independently hydrogen, substituted or unsubstituted C1 to C20 alkyl, substituted or unsubstituted C6 to C30 aryl, or substituted or unsubstituted C2 to C30 heteroaryl, wherein the alkyl, aryl and heteroaryl may include at least one substituent including —O—, —CO—O—, —CO—NH—, —NH—CO—, —O—CO—, or a combination thereof.

In Chemical Formulae 13-1 to 13-4, A¹ to A⁶ are the same or different and are each independently a single bond, —O—, —SO₂— or —C(R²⁰³)(R²⁰⁴)— (wherein, R²⁰³ and R²⁰⁴ are the same or different and are each independently hydrogen or substituted or unsubstituted C1 to C6 alkyl).

In Chemical Formulae 13-1 to 13-4, n¹ to n¹⁰ are the same or different and are each independently an integer of 0 to 4.

The functional diamine may include without limitation at least one compound represented by the following Chemical Formulae 14-1 to 14-4, or a combination thereof.

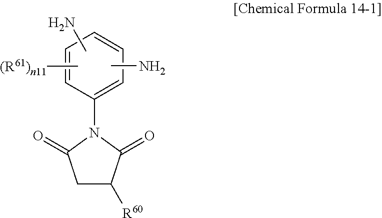

In Chemical Formula 14-1, R⁶⁰ is hydrogen, substituted or unsubstituted C1 to C20 alkyl, substituted or unsubstituted C6 to C30 aryl, or substituted or unsubstituted C2 to C30 heteroaryl.

In Chemical Formula 14-1, each R⁶¹ is independently hydrogen, substituted or unsubstituted C1 to C20 alkyl, substituted or unsubstituted C6 to C30 aryl, or substituted or unsubstituted C2 to C30 heteroaryl, and n¹¹ is an integer of 0 to 3.

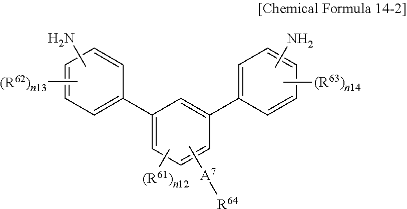

In Chemical Formula 14-2, R⁶¹, R⁶² and R⁶³ are the same or different and are each independently hydrogen, substituted or unsubstituted C1 to C20 alkyl, substituted or unsubstituted C6 to C30 aryl, or substituted or unsubstituted C2 to C30 heteroaryl.

In Chemical Formula 14-2, A⁷ is a single bond, —O—, —CO—O—, —CO—NH—, —NH—CO—, —O—CO—, or substituted or unsubstituted C1 to C₁₀ alkylene.

In Chemical Formula 14-2, R⁶⁴ is hydrogen, substituted or unsubstituted C1 to C20 alkyl, substituted or unsubstituted C6 to C30 aryl, or substituted or unsubstituted C2 to C30 heteroaryl, wherein the alkyl, aryl and heteroaryl may further include at least one substituent including —O—, —CO—O—, —CO—NH—, —NH—CO—, —O—CO—, or a combination thereof.

In Chemical Formula 14-2, n¹² may be 0 to 3, and n¹³ and n¹⁴ are the same or different and are each independently integers of 0 to 4.

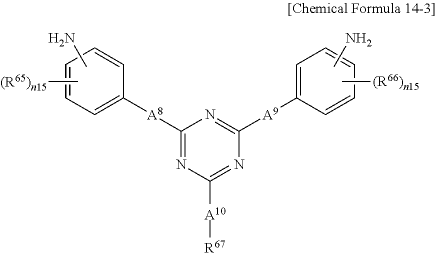

In Chemical Formula 14-3, R⁶⁵ and R⁶⁶ are the same or different and are each independently hydrogen, substituted or unsubstituted C1 to C20 alkyl, substituted or unsubstituted C6 to C30 aryl, or substituted or unsubstituted C2 to C30 heteroaryl.

In Chemical Formula 14-3, n¹⁵ and n¹⁶ are the same or different and are each independently integers of 0 to 4.

In Chemical Formula 14-3, R⁶⁷ is hydrogen, substituted or unsubstituted C1 to C20 alkyl, substituted or unsubstituted C6 to C30 aryl, or substituted or unsubstituted C2 to C30 heteroaryl.

In Chemical Formula 14-3, A⁸ and A⁹ are the same or different and are each independently a single bond, —O—, —CO—O— or —O—CO—, and A¹⁹ is a single bond, —O—, —CO—O—, —CO—NH—, —NH—CO—, or —O—CO—.

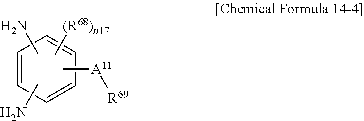

In Chemical Formula 14-4, each R⁶⁸ is independently hydrogen, substituted or unsubstituted C1 to C20 alkyl, substituted or unsubstituted C6 to C30 aryl, or substituted or unsubstituted C2 to C30 heteroaryl, and n¹⁷ is an integer of 0 to 3.

In Chemical Formula 14-4, R⁶⁹ is hydrogen, a substituted or unsubstituted C1 to C40 aliphatic organic group, a substituted or unsubstituted C2 to C40 aromatic organic group, or a substituted or unsubstituted C3 to C40 alicyclic organic group.

In Chemical Formula 14-4, A¹¹ is a single bond, —O—, —S—, —NH—, —CO—, —CO—O—, —O—CO—, —CO—NH—, or —NH—CO—.

The functional diamine may include without limitation at least one compound represented by the following Chemical Formulae 15-1 to 15-4, or a combination thereof.

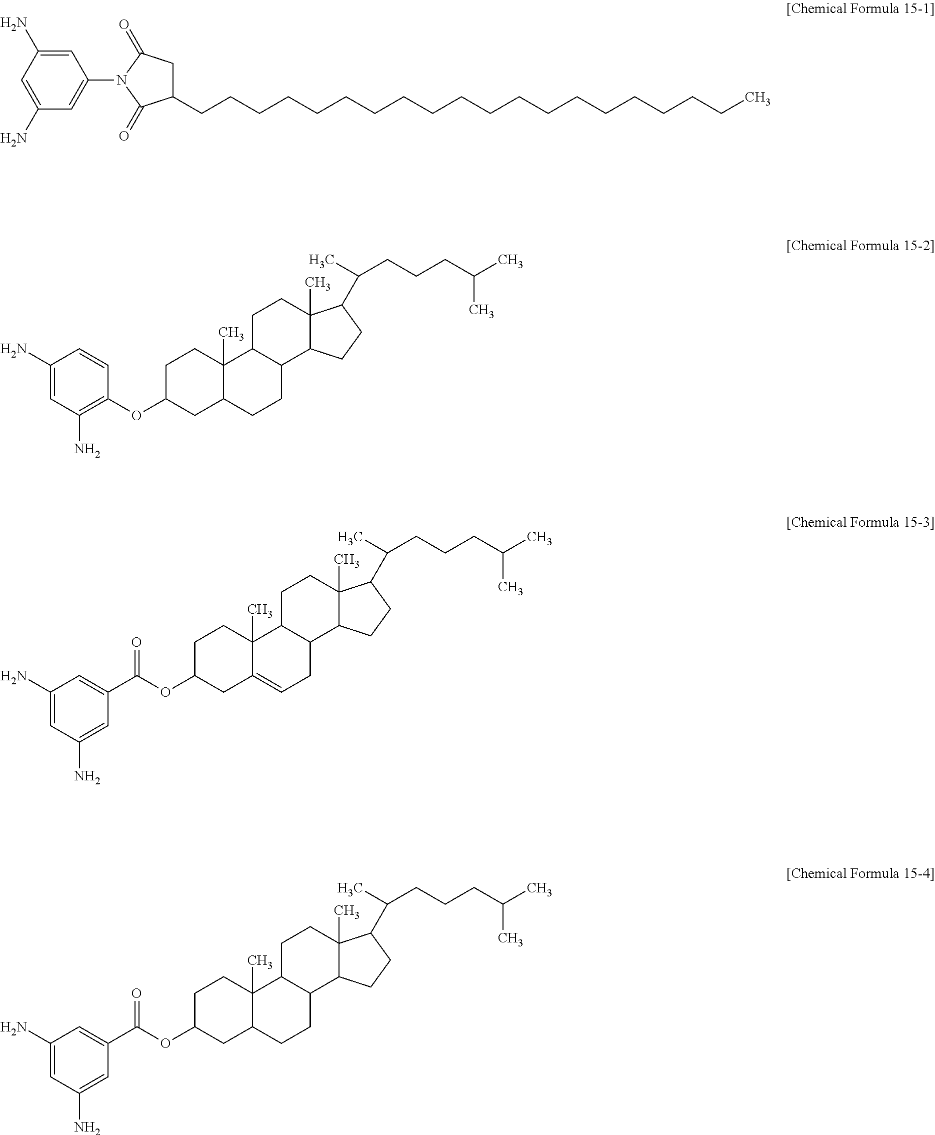 [SMILES: CCCCCCCCCCCCCCCCCCCCC1CC(=O)N(c2cc(N)cc(N)c2)C1=O ; CC(C)CCCC(C)C1CCC2C3CCC4CC(Oc5ccc(N)cc5N)CCC4(C)C3CCC12C ; CC(C)CCCC(C)C1CCC2C3CC=C4CC(OC(=O)c5cc(N)cc(N)c5)CCC4(C)C3CCC12C ; CC(C)CCCC(C)C1CCC2C3CCC4CC(OC(=O)c5cc(N)cc(N)c5)CCC4(C)C3CCC12C]

The polyamic acid including the repeating unit represented by the above Chemical Formula 1, polyamic acid including the repeating unit represented by the above Chemical Formula 5, and polyamic acid including the repeating unit represented by the above Chemical Formula 7 may be synthesized from acid dianhydride and diamine. The method of preparing polyamic acid by copolymerizing the acid dianhydride and the diamine is not specifically limited as long as it synthesizes the polyamic acid.

The polyimide including the repeating unit represented by the above Chemical Formula 2, polyimide including the repeating unit represented by the above Chemical Formula 6, and polyimide including the repeating unit represented by the above Chemical Formula 8 may be prepared by imidizing the polyamic acid including the repeating unit represented by the above Chemical Formula 1, polyamic acid including the repeating unit represented by the above Chemical Formula 5 and polyamic acid including the repeating unit represented by the above Chemical Formula 7. The method of preparing polyimide by imidizing polyamic acid is well known for the one skilled in this art, so the details are omitted.

Examples of the acid dianhydride may include without limitation alicyclic acid dianhydrides, aromatic acid dianhydrides, and the like, and combinations thereof.

Examples of the alicyclic acid dianhydride may include without limitation 1,2,3,4-cyclobutanetetracarboxylic acid dianhydride (CBDA), 5-(2,5-dioxotetrahydrofuryl)-3-methylcyclohexene-1,2-dicarboxylic acid anhydride (DOCDA), bicyclooctene-2,3,5,6-tetracarboxylic acid dianhydride (BODA), 1,2,3,4-cyclopentanetetracarboxylic acid dianhydride (CPDA), 1,2,4,5-cyclohexanetetracarboxylic acid dianhydride (CHDA), 1,2,4-tricarboxyl-3-methylcarboxylcyclopentanedianhydride, 1,2,3,4-tetracarboxylcyclopentanedianhydride and 2,3,5-tricarboxylcyclopentyl acetic acid dianhydride (2,3,5-tricarboxycyclopentyl acetic dianhydride, TCA-AH), and the like, and combinations thereof.

Examples of the tetravalent organic group derived from the alicyclic acid dianhydride may include at least one of the functional groups represented by the following Chemical Formulae 16-1 to 16-5, and combinations thereof, but is not limited thereto.

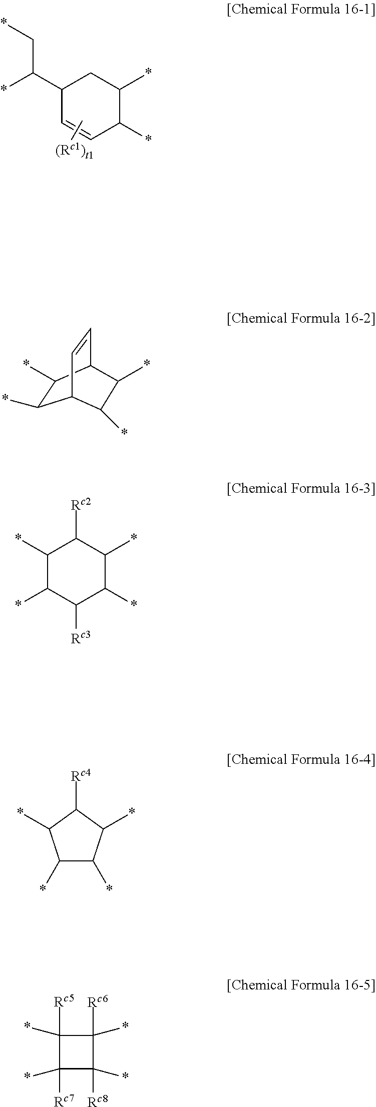

In Chemical Formula 16-1, each R^{c1} is independently hydrogen, substituted or unsubstituted C1 to C20 alkyl, substituted or unsubstituted C6 to C30 aryl, or substituted or unsubstituted C2 to C30 heteroaryl, and t¹ is an integer of 0 to 3. In Chemical Formula 16-1, when t¹ is an integer of 2 or more, each R^{c1} may be the same or different.

In Chemical Formulae 16-3 to 16-5, R^{c2} to R^{c8} are the same or different and are each independently hydrogen, substituted or unsubstituted C1 to C20 alkyl, substituted or unsubstituted C6 to C30 aryl, or substituted or unsubstituted C2 to C30 heteroaryl.

Examples of the aromatic acid dianhydride may include without limitation pyromellitic acid dianhydride (PMDA), biphthalic acid dianhydride (BPDA), oxydiphthalic acid dianhydride (ODPA), benzophenonetetracarboxylic acid dianhydride (BTDA), hexafluoroisopropylidene diphthalic acid dianhydride (6-FDA), and the like, and combinations thereof.

Examples of the tetravalent organic group derived from the aromatic acid dianhydride may include compounds selected from the following Chemical Formulae 17-1 and 17-2, and combinations thereof, but is not limited thereto.

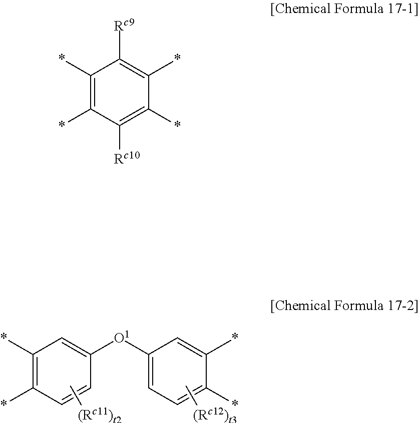

In Chemical Formula 17-1, R^{c9} and R^{c10} are the same or different and are each independently hydrogen, substituted or unsubstituted C1 to C20 alkyl, substituted or unsubstituted C6 to C30 aryl, or substituted or unsubstituted C2 to C30 heteroaryl.

In Chemical Formula 17-2, R^{c11} and R^{c12} are the same or different and are each independently hydrogen, substituted or unsubstituted C1 to C20 alkyl, substituted or unsubstituted C6 to C30 aryl, or substituted or unsubstituted C2 to C30 heteroaryl, and t² and t³ are the same or different and are each independently integers of 0 to 3. When t² is an integer of 2 or more, each R^{c11} may be the same or different, and t³ is an integer of 2 or more, each R^{c12} may be the same or different.

In Chemical Formula 17-2, D¹ may be a single bond, —O—, —CO—, substituted or unsubstituted C1 to C6 alkylene (e.g., —C(CF₃)₂—), substituted or unsubstituted C3 to C30 cycloalkylene, or substituted or unsubstituted C2 to C30 heterocycloalkylene.

When the polymer includes both the polyamic acid and the polyimide, the polyamic acid and the polyimide may be present in a weight ratio of about 1:99 to 50:50, and specifically about 10:90 to about 50:50.

In some embodiments, the combination of the polyamic acid and the polyimide may include the polyamic acid in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polyamic acid can be in a range from about any of the foregoing amounts to about any other of the foregoing amounts.

In some embodiments, the combination of the polyamic acid and the polyimide may include the polyimide in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polyimide can be in a range from about any of the foregoing amounts to about any other of the foregoing amounts.

When the combination of the polyamic acid and the polyimide includes the polyamic acid and the polyimide in an amount within the above range, alignment stability may be improved.

The liquid crystal alignment agent may include the polymer in an amount of about 1 wt % to about 25 wt %, for example about 3 wt % to about 20 wt % based on the total amount (weight) of the liquid crystal photoalignment agent. In some embodiments, the liquid crystal alignment agent may include the polymer in an amount of about 1, 2, 3, 4, 5, 6, 7, 8, 9, 10, 11, 12, 13, 14, 15, 16, 17, 18, 19, 20, 21, 22, 23, 24, or 25 wt %. Further, according to some embodiments of the present invention, the amount of the polymer can be in a range from about any of the foregoing amounts to about any other of the foregoing amounts.

When the liquid crystal alignment agent includes the polymer in an amount within the above range, printability and alignment properties of liquid crystals may be improved.

(B) Solvent

The liquid crystal photoalignment agent according to one embodiment includes a suitable solvent to dissolve the polymer. The solvent can provide a liquid crystal alignment agent that can have excellent spreadability and tackiness with a substrate.

Examples of the solvent may include without limitation N-methyl-2-pyrrolidone; N,N-dimethyl acetamide; N,N-dimethyl formamide; dimethyl sulfoxide; γ-butyrolactone; tetrahydrofuran (THF); and phenol-based solvents such as meta cresol, phenols, halogenated phenols, and the like, and combinations thereof.

The solvent may further include 2-butyl cellosolve (2-BC) to improve printability. The solvent may include 2-butyl cellosolve in an amount of about 1 wt % to about 50 wt %, for example about 10 to about 40 wt % based on the total amount (weight) of the solvent including 2-butyl cellosolve.

In some embodiments, the solvent may include 2-butyl cellosolve in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, or 50 wt %. Further, according to some embodiments of the present invention, the amount of 2-butyl cellosolve can be in a range from about any of the foregoing amounts to about any other of the foregoing amounts.

When the 2-butyl cellosolve is included in an amount within the above range, printability may be easily improved.

The solvent may further include a poor solvent. Examples of poor solvents include without limitation alcohols, ketones, esters, ethers, hydrocarbons, halogenated hydrocarbons, and the like, and combinations thereof, in an appropriate ratio as long as the polymer (A) is not precipitated. The poor solvents can decrease the surface energy of the liquid crystal photoalignment agent to improve the spreadability and the flatness during the coating.

The liquid crystal alignment agent can include the poor solvent in an amount of about 1 wt % to about 90 wt %, for example about 1 wt % to about 70 wt % based on the total amount (weight) of solvent including the poor solvent. In some embodiments, the liquid crystal alignment agent can include the poor solvent in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 48, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the poor solvent can be in a range from about any of the foregoing amounts to about any other of the foregoing amounts.

Examples of the poor solvent may include without limitation methanol, ethanol, isopropanol, cyclohexanol, ethylene glycol, propylene glycol, 1,4-butanediol, triethylene glycol, acetone, methylethylketone, cyclohexanone, methylacetate, ethylacetate, butylacetate, diethyloxalate, malonic acid ester, diethylether, ethylene glycol monomethylether, ethylene glycol dimethylether, ethylene glycol monoethylether, ethylene glycol phenylether, ethylene glycol phenylmethylether, ethylene glycol phenylethylether, diethylene glycol dimethylether, diethylene glycol ether, diethylene glycol monomethylether, diethylene glycol monoethylether, diethylene glycol monomethylether acetate, diethylene glycol monoethylether acetate, ethylene glycol methylether acetate, ethylene glycol ethylether acetate, 4-hydroxy-4-methyl-2-pentanone, 2-hydroxy ethyl propionate, 2-hydroxy-2-methyl ethyl propionate, ethoxy ethyl acetate, hydroxy ethyl acetate, methyl 2-hydroxy-3-methylbutanoate, methyl 3-methoxypropionate, ethyl 3-methoxypropionate, ethyl 3-ethoxypropionate, methyl 3-ethoxypropionate, methyl methoxy butanol, ethyl methoxy butanol, methyl ethoxy butanol, ethyl ethoxy butanol, tetrahydrofuran, dichloromethane, 1,2-dichloroethane, 1,4-dichloro butane, trichloro ethane, chlorobenzene, o-dichlorobenzene, hexane, heptane, octane, benzene, toluene, xylene, and the like, and combinations thereof.

Although the amount of solvent is not specifically limited in the liquid crystal photoalignment agent, it may be included in the liquid crystal photoalignment agent in an amount sufficient to provide a solid content of about 0.1 wt % to about 30 wt %, for example about 1 wt % to about 25 wt %.

In some embodiments, the liquid crystal alignment agent may have a solid content of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the solid content of the liquid crystal alignment agent can be in a range from about any of the foregoing amounts to about any other of the foregoing amounts.

When the solid content is in an amount within the above range, the liquid crystal alignment agent may be less affected by impurities on a substrate surface during the printing process to suitably maintain the uniformity of layer. This may prevent the deterioration of layer uniformity due to high viscosity during the printing process and provide an appropriate transmittance.

(C) Other Additive(s)

The liquid crystal photoalignment agent according to one embodiment may further include one or more other additives.

The other additive may include an epoxy compound. The epoxy compound can improve reliability and electro-optical characteristics. The epoxy compound may include at least one kind of epoxy compound having 2 to 8 epoxy groups, for example, 2 to 4 epoxy groups.

The liquid crystal alignment agent may include the epoxy compound in an amount of about 0.1 parts by weight to about 50 parts by weight, for example about 1 part by weight to about 30 parts by weight, based on about 100 parts by weight of the polymer (A). When the epoxy compound is included in an amount within the above range, appropriate printability and flatness may be provided during coating on the substrate, and also reliability and electro-optical properties may be easily improved.

Examples of the epoxy compound may include without limitation N,N,N′,N′-tetraglycidyl-4,4′-diaminophenylmethane (TGDDM), N,N,N′,N′-tetraglycidyl-4,4′-diaminophenylethane, N,N,N′,N′-tetraglycidyl-4,4′-diaminophenylpropane, N,N,N′,N′-tetraglycidyl-4,4′-diaminophenylbutane, N,N,N′,N′-tetraglycidyl-4,4′-diaminobenzene, ethylene glycoldiglycidylether, polyethylene glycoldiglycidylether, propylene glycoldiglycidylether, tripropylene glycoldiglycidylether, polypropylene glycoldiglycidylether, neopentylglycoldiglycidylether, 1,6-hexanedioldiglycidylether, glycerinediglycidylether, 2,2-dibromoneopentylglycoldiglycidylether, 1,3,5,6-tetraglycidyl-2,4-hexanediol, N,N,N′,N′-tetraglycidyl-1,4-phenylenediamine, N,N,N′,N′-tetraglycidyl-m-xylenediamine, N,N,N′,N′-tetraglycidyl-2,2′-dimethyl-4,4′-diaminobiphenyl, 2,2-bis[4-(N,N-diglycidyl-4-aminophenoxy)phenyl]propane, N,N,N′,N′-tetraglycidyl-4,4′-diaminodiphenylmethane, 1,3-bis(N,N-diglycidylaminomethyl)cyclohexane, 1,3-bis(N,N-diglycidylaminomethyl)benzene, and the like, and combinations thereof.

In addition, in order to improve printability, the liquid crystal alignment agent may further include other appropriate additives such as a surfactant and/or a coupling agent.

The liquid crystal photoalignment film according to another embodiment may be manufactured by using the liquid crystal photoalignment agent.

The liquid crystal photoalignment film may be formed by coating the liquid crystal photoalignment agent on a substrate. Methods of coating the liquid crystal photoalignment agent on a substrate may include without limitation spin coating, flexo printing, inkjet printing, and the like. Among them, the flexo printing may be generally used since it can provide excellent coating layer uniformity and can easily provide a large size print.

The substrate is not specifically limited as long as it has a high transparency. Examples of the substrate may include without limitation glass substrates, plastic substrates such as acrylic substrates or polycarbonate substrates, and the like. In addition, it may simplify the process if the substrate is formed with an indium-tin oxide (ITO) electrode or the like for driving liquid crystal.

In order to increase the coating uniformity, a pre-drying process may be performed at a temperature of room temperature to about 200° C., for example about 30° C. to about 150° C., and as another example about 40° C. to about 120° C. for about 1 minute to about 100 minutes after uniformly coating the liquid crystal photoalignment agent on the substrate. The pre-drying process may provide control of the volatilization of each component of the liquid crystal photoalignment agent, so as to provide a uniform coating layer having minimal or no deviation or variation.

The obtained liquid crystal photoalignment film may be used for a liquid crystal display with a uniaxial orientation by a polarization ultraviolet (UV) irradiation or without a uniaxial orientation in certain applications such as a vertical alignment layer or the like.

According to further another embodiment, a liquid crystal display is provided that includes the liquid crystal photoalignment film.

The following examples illustrate the present invention in more detail. These examples, however, should not in any sense be interpreted as limiting the scope of the present invention.

### Preparation of Polymer

### Preparation Example 1

0.7 moles of 4-(4,4,4-trifluorobutoxy)-benzoic acid-4-{2-[2-(2,4-diamino-phenyl)-ethoxycarbonyl]-vinyl}-phenyl ester represented by the following Chemical Formula 10-1 as diamine, 0.25 moles of paraphenylenediamine, and 0.05 moles of 5-heptaethyleneglycol-1,3-diamine represented by the following Chemical Formula 11 are put into a 4-necked flask including an agitator, a temperature controlling device, a nitrogen gas injection tube, and a cooler under dark room conditions with nitrogen passing therethrough, and N-methyl-2-pyrrolidone (NMP) is added thereto, preparing a mixed solution.

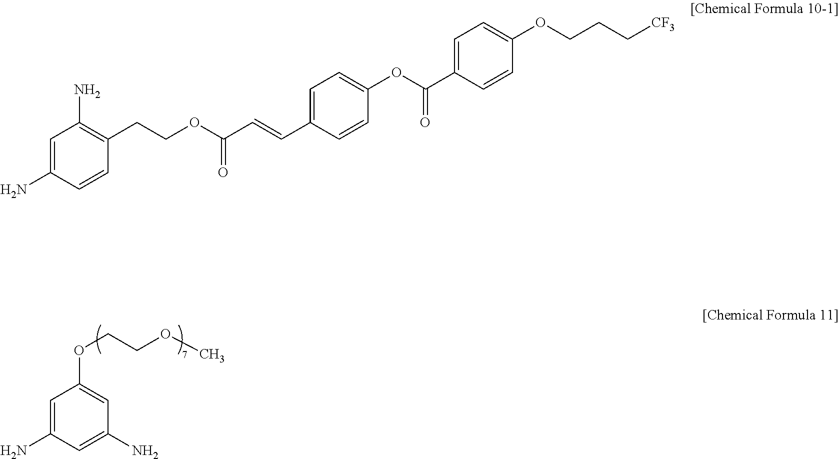

Next, 1.0 mole of solid 4,10-dioxa-tricyclo[6.3.1.0^{2,7}]dodecan-3,5,9,11-tetraone is added to the mixed solution, and the mixture is vigorously agitated for one hour. The agitated reactant is reacted for 24 hours, while its temperature is maintained at 30 to 60° C. to prepare a polyamic acid solution. The prepared solution is distilled to obtain polyamic acid

The polyamic acid has a weight average molecular weight of 170,000 g/mol.

### Preparation Example 2

3.0 moles of acetic anhydride and 5.0 moles of pyridine are added to the polyamic acid solution according to Preparation Example 1, and the mixture is cyclized at 80° C. for 4 hours and vacuum-distilled to remove a catalyst and a solvent to prepare polyimide. The polyimide has a weight average molecular weight of 160,000 g/mol.

### Preparation Example 3

Polyamic acid is prepared according to the same method as Preparation Example 1 except for using α,ω-dianiline dodecaethylene glycol represented by the following Chemical Formula 12 instead of 5-heptaethyleneglycol-1,3-diamine represented by the above Chemical Formula 11. The polyamic acid has a weight average molecular weight of 180,000 g/mol.

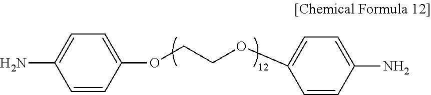

### Preparation Example 4

3.0 moles of acetic anhydride and 5.0 moles of pyridine are added to the polyamic acid solution according to Preparation Example 3, and the mixture is cyclized at 80° C. for 3 hours and vacuum-distilled to remove a catalyst and a solvent, preparing polyimide. The polyimide has a weight average molecular weight of 180,000 g/mol.

### Preparation Example 5

Polyamic acid was prepared according to the same method as Preparation Example 1 except for using 0.5 moles of 3,5-diaminobenzoate-3-cholestano represented by the following Chemical Formula 15-4 as diamine, 0.45 moles of paradiaminebenzene, and 0.05 moles of 5-heptaethyleneglycol-1,3-diamine represented by the above Chemical Formula 11. The polyamic acid has a weight average molecular weight of 190,000 g/mol.

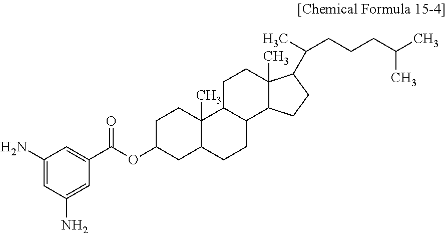 [SMILES: CC(C)CCCC(C)C1CCC2C3CCC4CC(OC(=O)c5cc(N)cc(N)c5)CCC4(C)C3CCC12C]

### Preparation Example 6

Polyimide is prepared by adding 3.0 moles of acetic anhydride and 5.0 moles of pyridine to the polyamic acid solution according to Preparation Example 5, cyclizing the mixture at 80° C. for 4 hours, and vacuum-distilling the cyclized reactant to remove a catalyst and a solvent. The polyimide has a weight average molecular weight of 180,000 g/mol.

### Preparation Example 7

Polyamic acid is prepared according to the same method as Preparation Example 1 except for using 0.5 moles of 3,5-diaminobenzoate-3-cholestanol represented by the above Chemical Formula 15-4 as diamine, 0.45 moles of diaminodiphenylmethane, and 0.05 moles of δ,ω-dianiline dodecaethylene glycol represented by the above Chemical Formula 12. The polyamic acid has a weight average molecular weight of 190,000 g/mol.

### Preparation Example 8

Polyimide is prepared by adding 3.0 moles of acetic anhydride and 5.0 moles of pyridine to the polyamic acid solution according to Preparation Example 7, cyclizing the mixture at 80° C. for 4 hours, and vacuum-distilling the cyclized reactant to remove a catalyst and a solvent. The polyimide has a weight average molecular weight of 180,000 g/mol.

### Preparation Example 9

Polyamic acid is prepared by adding 0.7 moles of 4-(4,4,4-trifluorobutoxy)-benzoic acid-4-{2-[2-(2,4-diamino-phenyl)-ethoxycarbonyl]-vinyl}-phenyl ester represented by the above Chemical Formula 10-1, 0.2 moles of paraphenylenediamine, and 0.1 moles of 5-heptaethyleneglycol-1,3-diamine represented by the above Chemical Formula 11. The polyamic acid has a weight average molecular weight of 200,000 g/mol.

### Preparation Example 10

Polyamic acid is prepared according to the same method as Preparation Example 1 except for using 0.65 moles of 4-(4,4,4-trifluorobutoxy)-benzoic acid-4-{2-[2-(2,4-diamino-phenyl)-ethoxycarbonyl]-vinyl}-phenyl ester represented by the above Chemical Formula 10-1, 0.2 moles of paraphenylenediamine, and 0.15 moles of 5-heptaethyleneglycol-1,3-diamine represented by Chemical Formula 11. The polyamic acid has a weight average molecular weight of 190,000 g/mol.

### Preparation Example 11

Polyamic acid is prepared according to the same method as Preparation Example 7 except for using 0.5 moles of 3,5-diaminobenzoate-3-cholestanol represented by the above Chemical Formula 15-4 as diamine, 0.4 moles of diaminodiphenylmethane, and 0.1 moles of α,ω-dianiline dodecaethylene glycol represented by the above Chemical Formula 12. The polyamic acid has a weight average molecular weight of 190,000 g/mol.

### Preparation Example 12

Polyamic acid is prepared according to the same method as Preparation Example 7 except for using 0.6 moles of 3,5-diaminobenzoate-3-cholestanol represented by the above Chemical Formula 15-4 as diamine, 0.25 moles of diaminodiphenylmethane, and 0.15 moles of α,ω-dianiline dodecaethylene glycol represented by the above Chemical Formula 12. The polyamic acid has a weight average molecular weight of 210,000 g/mol.

### Comparative Preparation Example 1

Polyamic acid is prepared according to the same method as Preparation Example 1 except for using 0.7 moles of 4-(4,4,4-trifluorobutoxy)-benzoic acid-4-{2-[2-(2,4-diamino-phenyl)-ethoxycarbonyl]-vinyl}-phenyl ester represented by the above Chemical Formula 10-1 as diamine and 0.3 moles of the paraphenylenediamine. The polyamic acid has a weight average molecular weight of 180,000 g/mol.

### Comparative Preparation Example 2

Polyimide is prepared by adding 3.0 moles of acetic anhydride and 5.0 moles of pyridine to the polyamic acid solution according to Comparative Preparation Example 1, cyclizing the mixture at 80° C. for 4 hours, and vacuum-distilled the cyclized reactant to remove a catalyst and a solvent. The polyimide has a weight average molecular weight of 180,000 g/mol.

### Comparative Preparation Example 3

Polyamic acid is prepared according to the same method as Preparation Example 1 except for using 0.5 moles of 3,5-diaminobenzoate-3-cholestanol represented by the above Chemical Formula 15-4 as diamine and 0.5 moles of the paradiaminebenzene. The polyamic acid has a weight average molecular weight of 190,000 g/mol.

### Comparative Preparation Example 4

Polyimide is prepared by adding 3.0 moles of acetic anhydride and 5.0 moles of pyridine to the polyamic acid solution according to Comparative Preparation Example 3, cyclizing the mixture at 80° C. for 4 hours, and vacuum-distilling the cyclized reactant to remove a catalyst and a solvent. The polyimide has a weight average molecular weight of 190,000 g/mol.

### Preparation of Liquid Crystal Photoalignment Agent

### Examples 1 to 12 and Comparative Examples 1 to 4

1g of N,N′-(methylenedi-4,1-phenylene)bis[N-(oxiranyl methyl)oxirane methaneamine represented by Chemical Formula 19 is added to 6g of each polymer prepared according to Preparation Examples 1 to 12 and Comparative Preparation Examples 1 to 4, and a mixed solvent prepared by mixing N-methyl-2-pyrrolidone (NMP), γ-butyrolactone, and 2-butyl cellosolve in a volume ratio of 3:4:3 is added thereto to provide a solid content of 7 wt %. The resulting mixture is agitated at room temperature for 24 hours, preparing a liquid crystal photoalignment agent.

Each prepared liquid crystal photoalignment agent has viscosity as provided in the following Table 1.

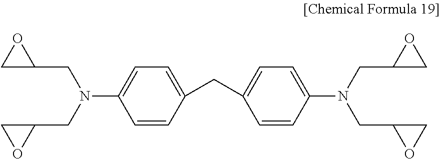 [SMILES: c1cc(N(CC2CO2)CC2CO2)ccc1Cc1ccc(N(CC2CO2)CC2CO2)cc1]

TABLE 1

| | | | Viscosity of liquid |
|---|---|---|---|
| | Polymer | | crystal photoalignment |
| | Kind | Amount (g) | agent (cps) |
| Example 1 | Preparation | 6 | 25.6 |
| | Example 1 | | |
| Example 2 | Preparation | 6 | 25.8 |
| | Example 2 | | |
| Example 3 | Preparation | 6 | 24.6 |
| | Example 3 | | |
| Example 4 | Preparation | 6 | 25.7 |
| | Example 4 | | |
| Example 5 | Preparation | 6 | 23.9 |
| | Example 5 | | |
| Example 6 | Preparation | 6 | 23.9 |
| | Example 6 | | |
| Example 7 | Preparation | 6 | 25.3 |
| | Example 7 | | |
| Example 8 | Preparation | 6 | 23.8 |
| | Example 8 | | |
| Example 9 | Preparation | 6 | 24.2 |
| | Example 9 | | |
| Example 10 | Preparation | 6 | 25.3 |
| | Example 10 | | |
| Example 11 | Preparation | 6 | 24.9 |
| | Example 11 | | |
| Example 12 | Preparation | 6 | 24.2 |
| | Example 12 | | |
| Comparative | Comparative | 6 | 26.8 |
| Example 1 | Preparation | | |
| | Example 1 | | |
| Comparative | Comparative | 6 | 26.4 |
| Example 2 | Preparation | | |
| | Example 2 | | |
| Comparative | Comparative | 6 | 26.4 |
| Example 3 | Preparation | | |
| | Example 3 | | |
| Comparative | Comparative | 6 | 26.6 |
| Example 4 | Preparation | | |
| | Example 4 | | |

Evaluation 1: End Film Uniformity of Liquid Crystal Photoalignment Film

Each liquid crystal photoalignment agent obtained from Examples 1 to 12 and Comparative Examples 1 to 4 is flexo printed on a glass substrate with washed ITO by an alignment layer printer (CZ 200®, manufactured by NAKAN), and the printed substrate is allowed to stand on a hot plate of 80° C. for 3 to 5 minutes to pre-dry the coat.

After pre-drying the substrate, the substrate is baked on a hot plate at 180° C. for 20 to 30 minutes to provide a substrate with a liquid crystal photoalignment film.

The film surfaces of the liquid crystal photoalignment films are observed by the naked eye and an electron microscope (MX50®, manufactured by Olympus Corporation) and then film thickness changes through the entire surface of substrate (central and end terminal parts) are measured. The results are shown in the following Table 2.

The film uniformity is determined as good in the case of having a thickness deviation of less than 0.005 μm, moderate in the case of having a thickness deviation of 0.005 to 0.01 μm, and bad in the case of having a thickness deviation of more than 0.01 μm.

Evaluation 2: Chemical Resistance

Each liquid crystal photoalignment agent according to Examples 1 to 12 and Comparative Examples 1 to 4 is coated to be 0.1 μm thick on a 10 cm×10 cm ITO glass substrate and cured at 80° C. and 220° C. Then, an alignment layer after a rubbing or exposure process is sufficiently cleaned on the surface using isopropyl alcohol and pure water and assembled to fabricate a LCD cell for a test. The cell is examined regarding whether or not the cleaning solvent produced a stain, while operated by applying a voltage ranging from 1V to 2V. The results are provided in the following Table 2.

In the following Table 2, a stain is marked as ‘Yes’, while no stain is marked as ‘No.’

Evaluation 3: Electrical Properties of Liquid Crystal Photoalignment Film

The electrical properties of liquid crystal photoalignment films obtained in Evaluation 1 are evaluated by using a liquid crystal cells with cell gaps of 4.75 μm and measuring voltage holding ratios (VHR) at room temperature and 60° C. and residual (DC) voltages. The results are shown in the following Table 2.

In the following Table 2, a voltage transmittance of greater than or equal to 99% is marked as “Good”, while a voltage transmittance of less than 99% is marked as “Bad.”

The voltage holding ratio represents the degree that the exterior electric source and the floating liquid crystal layer hold the charged voltage during an undefined period in an active matrix TFT-LCD, and a value approaching 100% is ideal. The voltage holding ratios are measured at room temperature and a high temperature, respectively.

The residual DC voltage represents a voltage applied to the liquid crystal layer by absorbing ionized impurities of the liquid crystal layer to the alignment layer without applying the exterior voltage, and a lower value is better. The residual DC voltage is measured using a curve (C-V) of electrical capacity change of the liquid crystal layer depending upon DC voltage application

TABLE 2

| | Voltage holding ratio (%) | | Residual | | | |
|---|---|---|---|---|---|---|
| | room temp. | high temp. | DC voltage | Voltage | End film | |
| | 25° C. | 60° C. | (mV) | transmittance | uniformity | Stains |
| Example 1 | 99.52 | 99.26 | 40 | Good | Good | None |
| Example 2 | 99.48 | 99.18 | 36 | Good | Good | None |
| Example 3 | 99.51 | 99.16 | 45 | Good | Good | None |
| Example 4 | 99.56 | 99.15 | 43 | Good | Good | None |
| Example 5 | 99.47 | 99.12 | 36 | Good | Good | None |
| Example 6 | 99.41 | 99.10 | 41 | Good | Good | None |
| Example 7 | 99.46 | 99.16 | 45 | Good | Good | None |
| Example 8 | 99.42 | 99.15 | 48 | Good | Good | None |
| Example 9 | 99.43 | 99.12 | 33 | Good | Good | None |
| Example 10 | 99.41 | 99.19 | 42 | Good | Good | None |
| Example 11 | 99.46 | 99.12 | 43 | Good | Good | None |
| Example 12 | 99.43 | 99.15 | 48 | Good | Good | None |
| Comparative | 98.55 | 97.41 | 57 | Bad | Bad | None |
| Example 1 | | | | | | |
| Comparative | 98.38 | 97.56 | 45 | Bad | Bad | None |
| Example 2 | | | | | | |
| Comparative | 98.45 | 97.33 | 37 | Bad | Bad | None |
| Example 3 | | | | | | |
| Comparative | 98.58 | 97.48 | 37 | Bad | Bad | None |
| Example 4 | | | | | | |

Based on Table 2, the cells including the liquid crystal photoalignment agents according to Examples 1 to 12, respectively, have good electrical properties such as a voltage holding ratio, a residual DC voltage, and a voltage transmittance. In addition, the end film has excellent printing, uniformity, and no stain in a chemical resistance evaluation. The reason is that a soft part in the polymer increases mobility of the polymer at a low temperature during the curing and sufficiently increases the degree of the curing.

In contrast, for Comparative Examples 1 to 4, a polymer has low fluidity and is not sufficiently cured, bringing about a low voltage holding ratio, deteriorating curing uniformity, and resulting in a bad voltage transmittance. In addition, the films have a thickness difference between middle and end, deteriorating overall printing uniformity.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A liquid crystal photoalignment agent, comprising:
a polymer including a polyamic acid including a repeating unit represented by the following Chemical Formula 1, a polyimide including a repeating unit represented by the following Chemical Formula 2, or a combination thereof: 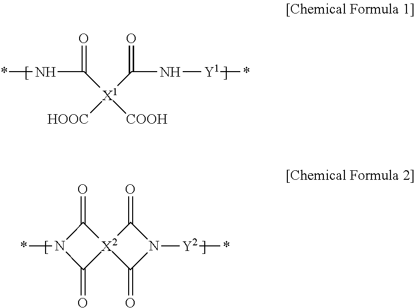
wherein, in Chemical Formulae 1 and 2,
X¹ and X² are the same or different and are each independently a tetravalent organic group derived from alicyclic acid dianhydride or aromatic acid dianhydride,
Y¹ and Y² are the same or different and are each independently a divalent organic group derived from diamine, wherein the diamine includes a photodiamine and at least one diamine represented by the following Chemical Formulae 3 and 4 or a combination thereof, 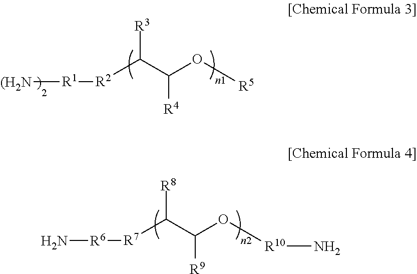
wherein, in Chemical Formulae 3 and 4,
R¹ and R⁶ are the same or different and are each independently a substituted or unsubstituted aliphatic organic group, a substituted or unsubstituted alicyclic organic group, or a substituted or unsubstituted aromatic organic group,
R² and R⁷ are the same or different and are each independently a single bond, —O—, —CO—O—, —CO—NH—, —NH—CO—, or —O—CO—,
R³, R⁴, R⁵, R⁸ and R⁹ are the same or different and are each independently hydrogen, substituted or unsubstituted C1 to C20 alkyl, or substituted or unsubstituted C6 to C30 aryl,
R¹⁰ is a single bond, substituted or unsubstituted C1 to C20 alkylene, or substituted or unsubstituted C6 to C30 arylene, and
n¹ and n² are the same or different and are each independently integers ranging from 1 to 100.

2. The liquid crystal photoalignment agent of claim 1, wherein the photodiamine comprises a compound represented by the following Chemical Formula 9-1 to 9-9, or a combination thereof: 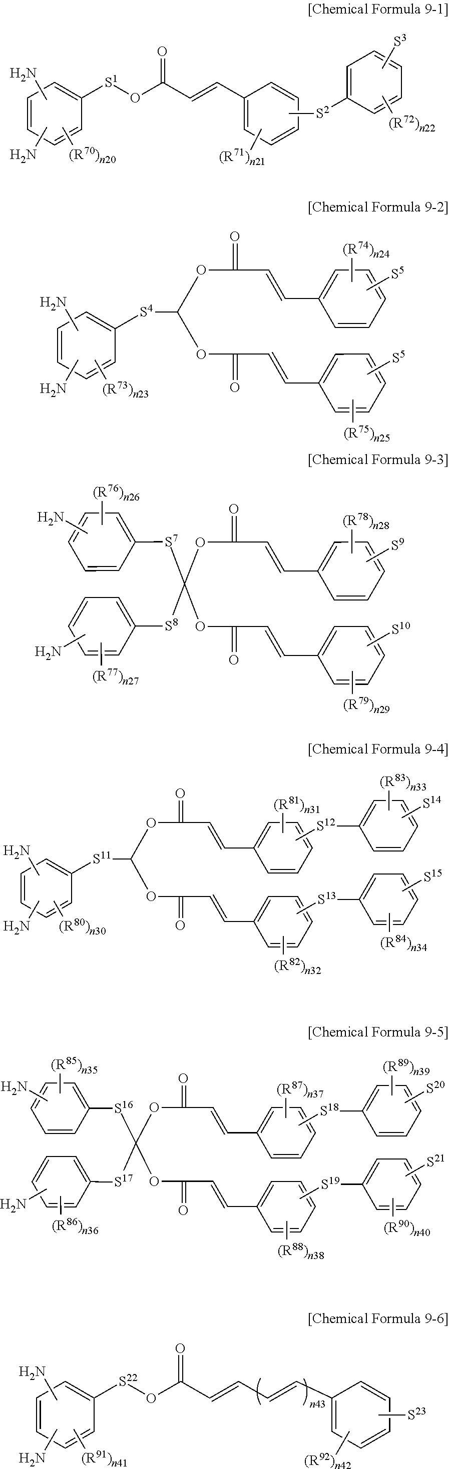
wherein, in Chemical Formulae 9-1 to 9-6,
S¹, S², S⁴, S⁷, S⁸, S¹¹, S¹², S¹³, S¹⁶, S¹⁷, S¹⁸, S¹⁹, and S²² are the same or different and are each independently a single bond, substituted or unsubstituted C1 to C10 alkylene, —O—, —CO—O—, —CO—NH—, —NH—CO—, or —O—CO—,
S³, S⁵, S⁶, S⁹, S¹⁰, S¹⁴, S¹⁵, S²⁰, S²¹, and S²³ are the same or different and are each independently substituted or unsubstituted C1 to C30 alkyl, substituted or unsubstituted C1 to C30 alkoxy, or substituted or unsubstituted C2 to C30 ether,
R⁷⁰ to R⁹² are the same or different and are each independently hydrogen or substituted or unsubstituted C1 to C10 alkyl,
n²⁰, n²³, n³⁰ and n⁴¹ are the same or different and are each independently integers ranging from 0 to 3,
n²¹, n²², n²⁴ to n²⁹, n³¹ to n⁴⁰, and n⁴² are the same or different and are each independently integers ranging from 0 to 4, and
n⁴³ is an integer ranging from 0 to 5, 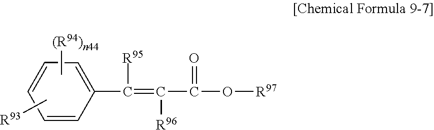
wherein, in Chemical Formula 9-7,
R⁹³ is a diamine group including a substituted or unsubstituted C6 to C30 aromatic diamine group or substituted or unsubstituted linear or branched C1 to C24 alkylene diamine group,
R⁹⁴ is hydrogen, substituted or unsubstituted C1 to C20 alkyl, substituted or unsubstituted C6 to C30 aryl, or substituted or unsubstituted C2 to C30 heteroaryl,
n⁴⁴ is an integer ranging from 0 to 4,
R⁹⁵ and R⁹⁶ are the same or different and are each independently hydrogen, halogen, a cyano group, or substituted or unsubstituted C1 to C12 alkyl, and
R⁹⁷ is hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group, 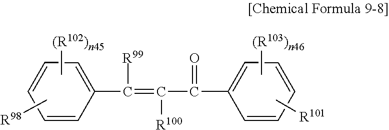
wherein, in Chemical Formula 9-8,
R⁹⁸ is a diamine group including a substituted or unsubstituted C6 to C30 aromatic diamine group or substituted or unsubstituted linear or branched C1 to C24 alkylene diamine group,
R¹⁰² and R¹⁰³ are the same or different and are each independently hydrogen, substituted or unsubstituted C1 to C20 alkyl, substituted or unsubstituted C6 to C30 aryl, or substituted or unsubstituted C2 to C30 heteroaryl,
n⁴⁵ and n⁴⁶ are the same or different and are each independently integers ranging from 0 to 4,
R⁹⁹ and R¹⁰⁰ are the same or different and are each independently hydrogen, halogen, a cyano group, or substituted or unsubstituted C1 to C12 alkyl, and
R¹⁰¹ is hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group, 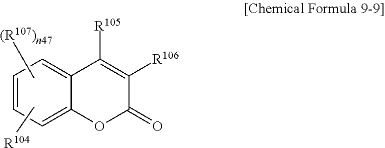
wherein, in Chemical Formula 9-9,
R¹⁰⁴ is a diamine group including a substituted or unsubstituted C6 to C30 aromatic diamine group or substituted or unsubstituted linear or branched C1 to C24 alkylene diamine group,
R¹⁰⁷ is hydrogen, substituted or unsubstituted C1 to C20 alkyl, substituted or unsubstituted C6 to C30 aryl, or substituted or unsubstituted C2 to C30 heteroaryl,
n⁴⁷ is an integer ranging from 0 to 3, and
R¹⁰⁵ and R¹⁰⁶ are the same or different and are each independently hydrogen, halogen, a cyano group, or substituted or unsubstituted C1 to C12 alkyl.

3. The liquid crystal photoalignment agent of claim 1, wherein the photodiamine comprises a compound represented by the following Chemical Formulae 10-1 and 10-2, or a combination thereof:

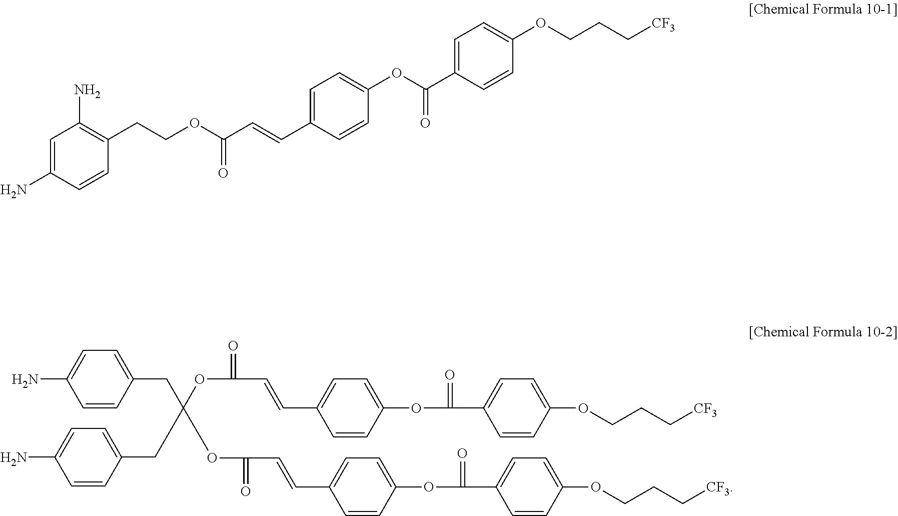 [SMILES: Nc1ccc(CCOC(=O)/C=C/c2ccc(OC(=O)c3ccc(OCCCC(F)(F)F)cc3)cc2)c(N)c1 ; Nc1ccc(CC(Cc2ccc(N)cc2)(OC(=O)/C=C/c2ccc(OC(=O)c3ccc(OCCCC(F)(F)F)cc3)cc2)OC(=O)/C=C/c2ccc(OC(=O)c3ccc(OCCCC(F)(F)F)cc3)cc2)cc1]

4. The liquid crystal photoalignment agent of claim 1, wherein the diamine of Chemical Formulae 3 and 4 comprises a compound represented by the following Chemical Formulae 11 and 12, or a combination thereof:

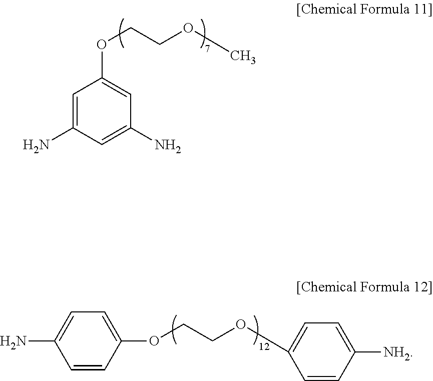

5. The liquid crystal photoalignment agent of claim 1, wherein the diamine comprises about 85 to about 99 mol % of the photodiamine and about 1 to about 15 mol % of the diamine represented by Chemical Formula 3, Chemical Formula 4, or a combination of Chemical Formula 3 and Chemical Formula 4.

6. The liquid crystal photoalignment agent of claim 1, wherein the polymer has a weight average molecular weight of about 100,000 to about 500,000 g/mol.

7. The liquid crystal photoalignment agent of claim 1, wherein the liquid crystal photoalignment agent has a solid content of about 0.1 to about 30 wt %.

8. A liquid crystal photoalignment agent, comprising
a first polymer comprising polyamic acid including a repeating unit represented by the following Chemical Formula 5, polyimide including a repeating unit represented by the following Chemical Formula 6, or a combination thereof; and a second polymer comprising polyamic acid including a repeating unit represented by the following Chemical Formula 7, polyimide including a repeating unit represented by the following Chemical Formula 8, or a combination thereof: 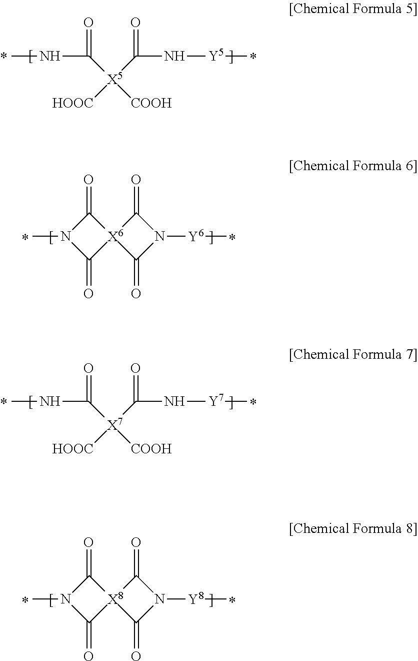
wherein, in Chemical Formulae 5 to 8,
X⁵ to X⁸ are the same or different and are each independently a tetravalent organic group derived from alicyclic acid dianhydride or aromatic acid dianhydride,
Y⁵ and Y⁶ are the same or different and are each independently a divalent organic group derived from photodiamine, and
Y⁷ and Y⁸ are the same or different and are each independently a divalent organic group derived from at least one diamine represented by the following Chemical Formulae 3 and 4, or a combination thereof: 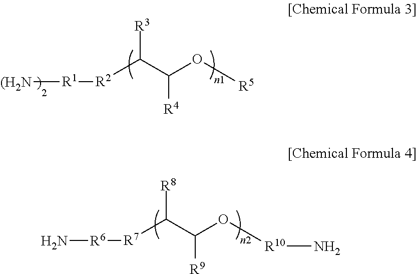
wherein, in Chemical Formulae 3 and 4,
R¹ and R⁶ are the same or different and are each independently a substituted or unsubstituted aliphatic organic group, a substituted or unsubstituted alicyclic organic group, or a substituted or unsubstituted aromatic organic group,
R² and R⁷ are the same or different and are each independently a single bond, —O—, —CO—O—, —CO—NH—, —NH—CO—, or —O—CO—,
R³, R⁴, R⁵, R⁸ and R⁹ are the same or different and are each independently hydrogen, substituted or unsubstituted C1 to C20 alkyl, or substituted or unsubstituted C6 to C30 aryl,
R¹⁰ is a single bond, substituted or unsubstituted C1 to C20 alkylene, or substituted or unsubstituted C6 to C30 arylene, and
n¹ and n² are the same or different and are each independently integers ranging from 1 to 100.

9. The liquid crystal photoalignment agent of claim 8, wherein the photodiamine comprises a compound represented by the following Chemical Formula 9-1 to 9-9, or a combination thereof: 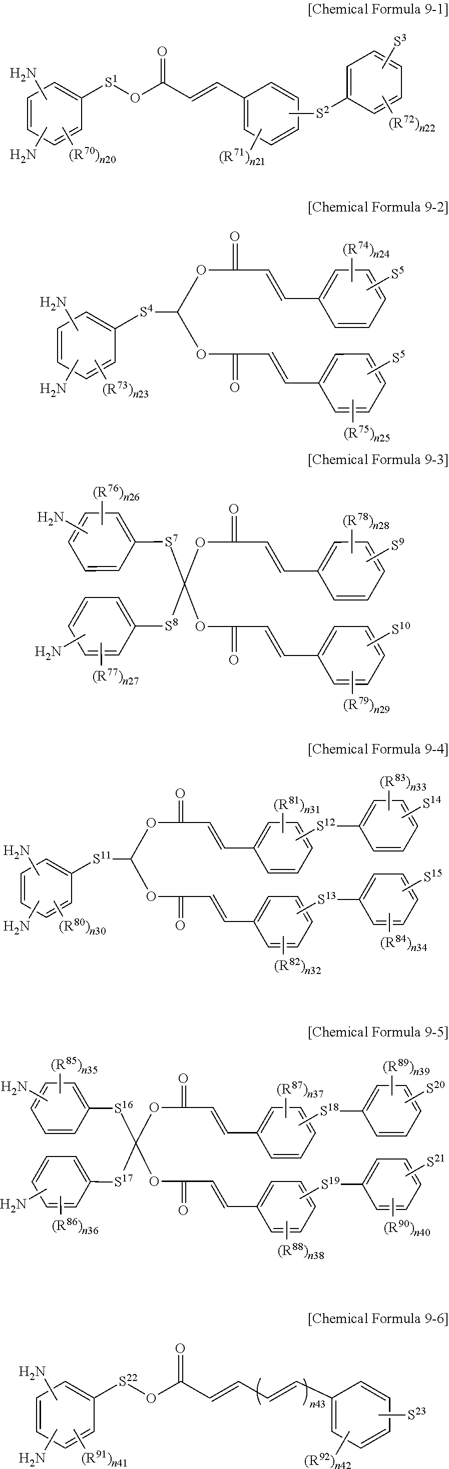
wherein, in Chemical Formulae 9-1 to 9-6,
S¹, S², S⁴, S⁷, S⁸, S¹¹, S¹², S¹³, S¹⁶, S¹⁷, S¹⁸, S¹⁹, and S²² are the same or different and are each independently a single bond, substituted or unsubstituted C1 to C10 alkylene, —O—, —CO—O—, —CO—NH—, —NH—CO—, or —O—CO-0| [symbol] ,
S³, S⁵, S⁶, S⁹, S¹⁰, S¹⁴, S¹⁵, S²⁰, S²¹, and S²³ are the same or different and are each independently substituted or unsubstituted C1 to C30 alkyl, substituted or unsubstituted C1 to C30 alkoxy, or substituted or unsubstituted C2 to C30 ether,
R⁷⁰ to R⁹² are the same or different and are each independently hydrogen or substituted or unsubstituted C1 to C10 alkyl,
n²⁰, n²³, n³⁰ and n⁴¹ are the same or different and are each independently integers ranging from 0 to 3,
n²¹, n²², n²⁴ to n²⁹, n³¹ to n⁴⁰, and n⁴² are the same or different and are each independently integers ranging from 0 to 4, and
n⁴³ is an integer ranging from 0 to 5, 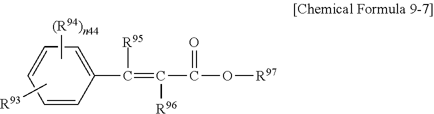
wherein, in Chemical Formula 9-7,
R⁹³ is a diamine group including a substituted or unsubstituted C6 to C30 aromatic diamine group or a substituted or unsubstituted C1 to C24 linear or branch alkylene diamine group,
R⁹⁴ is hydrogen, substituted or unsubstituted C1 to C20 alkyl, substituted or unsubstituted C6 to C30 aryl, or substituted or unsubstituted C2 to C30 heteroaryl,
n⁴⁴ is an integer ranging from 0 to 4,
R⁹⁵ and R⁹⁶ are the same or different and are each independently hydrogen, halogen, a cyano group, or substituted or unsubstituted C1 to C12 alkyl, and
R⁹⁷ is hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group, 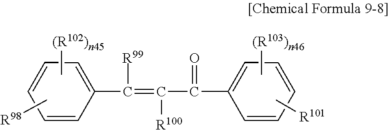
wherein, in Chemical Formula 9-8,
R⁹⁸ is a diamine group including a substituted or unsubstituted C6 to C30 aromatic diamine group or a substituted or unsubstituted C1 to C24 linear or branch alkylene diamine group,
R¹⁰² and R¹⁰³ are the same or different and are each independently hydrogen, substituted or unsubstituted C1 to C20 alkyl, substituted or unsubstituted C6 to C30 aryl, or substituted or unsubstituted C2 to C30 heteroaryl,
n⁴⁵ and n⁴⁶ are the same or different and are each independently integers ranging from 0 to 4,
R⁹⁹ and R¹⁰⁰ are the same or different and are each independently hydrogen, halogen, a cyano group, or substituted or unsubstituted C1 to C12 alkyl, and
R¹⁰¹ is hydrogen, substituted or unsubstituted C1 to C30 alkyl, substituted or unsubstituted C7 to C30 alkylaryl, substituted or unsubstituted C6 to C30 aryl, a substituted or unsubstituted C3 to C30 alicyclic organic group, a substituted or unsubstituted pyrimidinyl group, a substituted or unsubstituted pyridinyl group, a substituted or unsubstituted thiophenyl group, a substituted or unsubstituted furanyl group, or a substituted or unsubstituted naphthyl group, 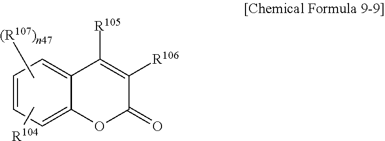
wherein, in Chemical Formula 9-9,
R¹⁰⁴ is a diamine group including a substituted or unsubstituted C6 to C30 aromatic diamine group or a substituted or unsubstituted C1 to C24 linear or branch alkylene diamine group,
R¹⁰⁷ is hydrogen, substituted or unsubstituted C1 to C20 alkyl, substituted or unsubstituted C6 to C30 aryl, or substituted or unsubstituted C2 to C30 heteroaryl,
n⁴⁷ is an integer ranging from 0 to 3, and
R¹⁰⁵ and R¹⁰⁶ are the same or different and are each independently hydrogen, halogen, a cyano group, or substituted or unsubstituted C1 to C12 alkyl.

10. The liquid crystal photoalignment agent of claim 8, wherein the photodiamine comprises a compound represented by the following Chemical Formulae 10-1 and 10-2 or a combination thereof:

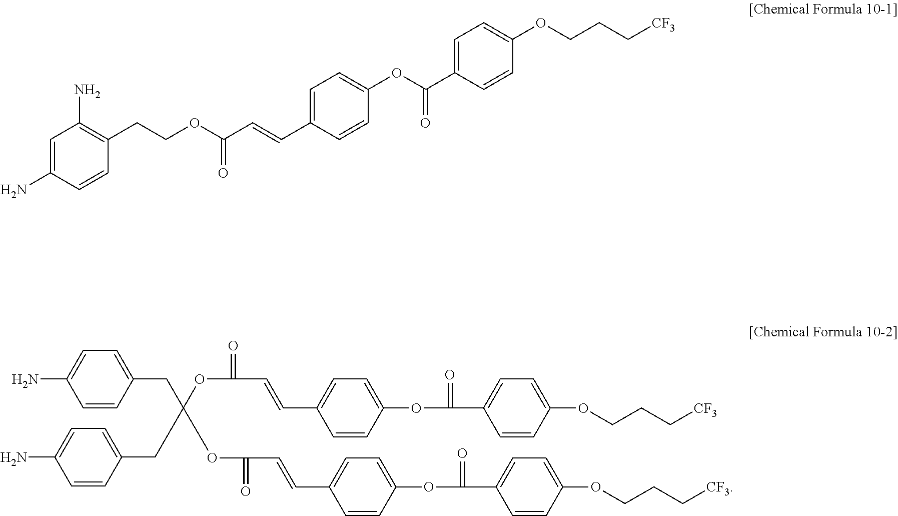 [SMILES: Nc1ccc(CCOC(=O)/C=C/c2ccc(OC(=O)c3ccc(OCCCC(F)(F)F)cc3)cc2)c(N)c1 ; Nc1ccc(CC(Cc2ccc(N)cc2)(OC(=O)/C=C/c2ccc(OC(=O)c3ccc(OCCCC(F)(F)F)cc3)cc2)OC(=O)/C=C/c2ccc(OC(=O)c3ccc(OCCCC(F)(F)F)cc3)cc2)cc1]

11. The liquid crystal photoalignment agent of claim 8, wherein the diamine of Chemical Formulae 3 and 4 comprises at least one compound represented by the following Chemical Formulae 11 and 12 or a combination thereof:

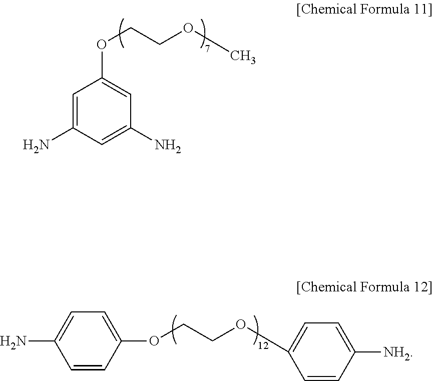

12. The liquid crystal photoalignment agent of claim 8, wherein the liquid crystal photoalignment agent comprises about 85 to about 99 mol % of the first polymer and about 1 to about 15 mol % of the second polymer.

13. The liquid crystal photoalignment agent of claim 8, wherein: the first polymer has a weight average molecular weight of about 100,000 to about 500,000 g/mol, and
the second polymer has a weight average molecular weight of about 100,000 to about 500,000 g/mol.

14. The liquid crystal photoalignment agent of claim 8, wherein the liquid crystal photoalignment agent has a solid content of about 0.1 to about 30 wt %.

15. A liquid crystal photoalignment film manufactured by applying the liquid crystal photoalignment agent according to claim 1 on a substrate.

16. A liquid crystal display including the liquid crystal photoalignment film according to claim 15.
